(19) United States
(12) Patent Application Publication
(10) Pub. No.: US 2026/0002012 A1
(43) Pub. Date: Jan. 1, 2026

(54) METHODS OF CHEMICAL DECONSTRUCTION AND UPCYCLING OF WASTE POLYMERS INTO VERSATILE VITRIMER ADHESIVES

(71) Applicant: UT-Battelle, LLC, Oak Ridge, TN (US)

(72) Inventors: Md Anisur Rahman, Knoxville, TN (US); Mary Danielson, Knoxville, TN (US); Tomonori Saito, Knoxville, TN (US)

(21) Appl. No.: 19/248,834

(22) Filed: Jun. 25, 2025

Related U.S. Application Data
(60) Provisional application No. 63/664,510, filed on Jun. 26, 2024.

(51) Int. Cl. C08J 11/28; C08J 11/22; C09J 179/02

(52) U.S. Cl. CPC C08J 11/28; C08J 11/22; C09J 179/02; C08J 2379/08

(57) ABSTRACT

A method of deconstructing and upcycling used polymeric material containing carbonyl groups in the backbone of the polymer comprising: (i) reacting the polymeric material with a polyamine molecule under conditions that result in covalent attachment of the polyamine molecule with the polymer in the polymeric material to produce an aminated monomer, wherein the aminated monomer contains a multiplicity of free unreacted amino groups from the polyamine molecule, and the polyamine molecule contains at least three amino groups; and (ii) reacting the aminated monomer with a poly(acylacetate) compound under conditions that result in reaction between a portion of the free unreacted amino groups in the aminated monomer and carbonyl groups in the bis(acylacetate) compound of Formula (3) to result in a crosslinked polymer containing vinylogous urethane covalent linkages and free unreacted amino groups. A method for bonding surfaces together by use of the above described crosslinked polymer is also disclosed herein.

### CROSS REFERENCE TO RELATED APPLICATION

The present application claims benefit of U.S. Provisional Application No. 63/664,510, filed on Jun. 26, 2024, all of the contents of which are incorporated herein by reference.

### STATEMENT REGARDING FEDERALLY SPONSORED RESEARCH

This invention was made with government support under Prime Contract No. DE-AC05-00OR22725 awarded by the U.S. Department of Energy. The government has certain rights in the invention.

### FIELD OF THE DISCLOSURE

The present disclosure generally relates to methods of breaking down plastic waste into useful products and also recycling plastic waste. The present disclosure more particularly relates to methods of deconstructing polyethylene terephthalate (PET) waste into useful monomeric and polymeric products such as vitrimer adhesive materials.

### BACKGROUND

Plastics are critical in facilitating the comfort and quality of everyday life. Most plastics are discarded after a single use, wasting the energy and carbon consumed for their production and incurring environmental costs. The production of commodity polymers in the U.S. alone requires an estimated 3.2 quadrillion BTUs of energy annually and generates 104 MMT CO2e of greenhouse gas (GHG) emissions. A 2018 study by the EPA revealed that 76% of produced plastic mass is landfilled annually, inevitably wasting the feedstock resources, energy, and carbon used for their production.

With a plastic waste production rate of 400 million tons per year, a systemic need for recycling, both physical and chemical, is needed. Currently, crosslinked plastic products are very difficult to recycle given the strength of the covalent bonds holding the polymer plastic together. Thus, most crosslinked plastics end up being disposed of, thus filling landfills and contaminating the oceans. Similarly, plastics that can be physically or chemically recycled are often converted into monomers and oligomers. While these monomers can be used to make new plastics, the cost of using the recycled monomer is more expensive than synthesizing and using freshly made monomer. In many cases, the recycled products are often burned, which contributes to the carbon content of Earth's atmosphere. Methods for breaking down and upcycling existing plastic products into polymers that can be more easily recycled are generally not available.

Thus, efficient processes for plastics recycling and upcycling are needed to mitigate these losses and to combat the accumulation of plastic waste in the environment, which is now estimated to be on the order of 108 tons of used, non-biodegradable material. Thus, closed-loop production and recycling processes are needed to mitigate energy and carbon loss toward a net-zero carbon economy. However, although much effort has been made in this respect, efficient and low-cost processes for recycling and upcycling of plastic waste remains a significant challenge. Thus, there would be a significant benefit in a method that can efficiently deconstruct and upcycle plastic waste, particularly PET, considering the ubiquitous nature of PET in plastic waste.

### SUMMARY

The present disclosure is directed to a novel method for deconstructing and upcycling condensation polymer waste, such as polyethylene terephthalate (PET) waste, into one or more useful monomeric or polymeric products. The method disclosed herein is advantageously cost efficient, straightforward, and capable of being scaled up to make it industrially feasible. In some embodiments, the method upcycles the polymer waste into a vitrimer adhesive material, wherein it is understood that a vitrimer possesses dynamic crosslinking bonds.

In particular embodiments, the present disclosure is directed to a method of deconstructing and upcycling used (waste) polymeric material containing carbonyl groups in the backbone of the polymer by the following steps:

(i) reacting the polymeric material with a polyamine molecule under conditions that result in covalent attachment of the polyamine molecule with the polymer in the polymeric material to produce an aminated monomer, wherein the aminated monomer contains a multiplicity of free unreacted amino groups from the polyamine molecule, and the polyamine molecule contains at least three amino groups; and

(ii) reacting the aminated monomer with a poly(acylacetate) compound of the formula:

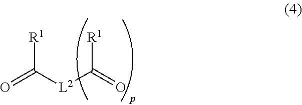

wherein: L² represents a hydrocarbon linker containing 1-50 carbon atoms and optionally containing one or more heteroatoms selected from N, O, S, and Si, wherein L² contains at least one ester-containing group of the formula —CH₂C (O)O—; R¹ is independently, in each instance, selected from H atom and hydrocarbon groups containing 1-3 carbon atoms; and p is an integer of 1-5; wherein the method is performed under conditions that result in the reaction between a portion of the free unreacted amino groups in the aminated monomer and carbonyl groups in the bis(acylacetate) compound of Formula (3) to result in a crosslinked polymer containing vinylogous urethane covalent linkages and free unreacted amino groups. The polymer waste may be or include one or more polymers selected from, for example, polyesters, polycarbonates, polyamides, and polyurethanes.

In particular embodiments, the waste polymeric material is or includes polyethylene terephthalate (PET), wherein:

step (i) proceeds by the following reaction:

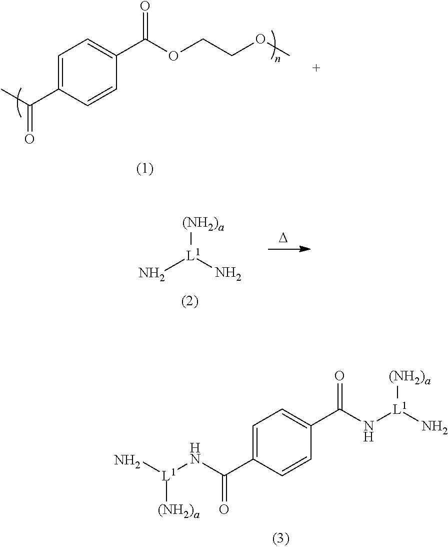

wherein L¹ is independently selected, in each instance, from hydrocarbon linkers containing at least three carbon atoms and optionally containing one or more heteroatoms selected from N, O, S, and Si; and subscript a is independently, in each instance, an integer of at least 1; and step (ii) produces a vitrimer crosslinked polymer comprising A and B units in accordance with the following scheme:

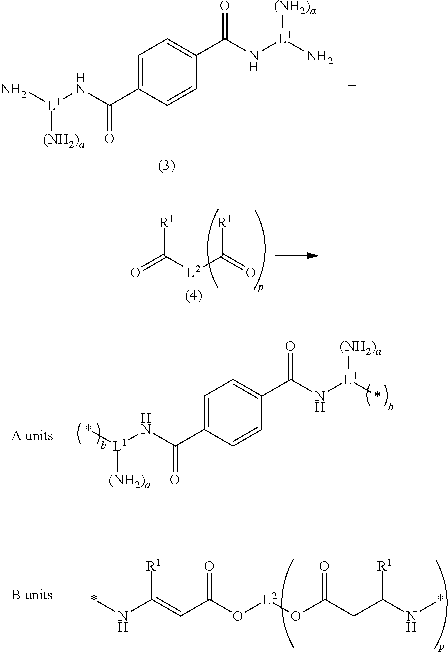

wherein: the asterisks (*) in A units represent covalent bond connection points with asterisks in B units; L¹ is independently selected, in each instance, from hydrocarbon linkers containing at least three carbon atoms and optionally containing one or more heteroatoms selected from N, O, S, and Si; L² represents a hydrocarbon linker containing 1-50 carbon atoms and optionally containing one or more heteroatoms selected from N, O, S, and Si; R³ is independently, in each instance, selected from H atom and hydrocarbon groups containing 1-3 carbon atoms; subscript a is independently, in each instance, an integer of at least 1; subscript b is independently, in each instance, an integer of at least 1; and subscript p is an integer of 1-5.

In another aspect, the present disclosure is directed to vinylogous urethane compounds having the following formula:

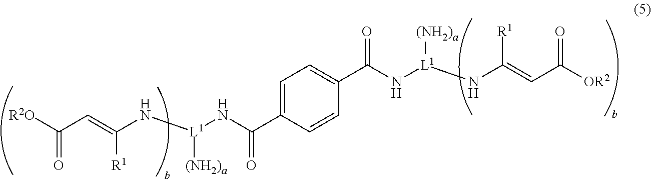

wherein: L¹ is independently selected, in each instance, from hydrocarbon linkers containing at least three carbon atoms and optionally one or more heteroatoms selected from N, O, S, and Si; R³ is independently, in each instance, selected from H atom and hydrocarbon groups containing 1-3 carbon atoms; R⁴ is independently, in each instance, selected from hydrocarbon groups containing at least one carbon atom and optionally containing one or more heteroatoms selected from N, O, S, and Si wherein, optionally, two R⁴ groups from different molecules of Formula (2) may interconnect, optionally repetitively, through a hydrocarbon linker L³ containing at least one carbon atom and optionally one or more heteroatoms selected from N, O, S, and Si; subscript a is independently selected, in each instance, from 0 or an integer of at least 1; and subscript b is independently selected, in each instance, from an integer of at least 1.

In another aspect, the present disclosure is directed to a method of bonding first and second surfaces together by placing an adhesive composition between the first and second surfaces and hot pressing the surfaces at a temperature of 80° C. to 200° C., wherein the adhesive composition is or includes a vitrimer adhesive polymer containing A and B units, as described above. In some embodiments, at least one of the first and second surfaces is a metal surface, plastic surface, ceramic surface, or a matrix composite surface.

In particular embodiments, the present disclosure provides a straightforward approach to converting PET (typically as waste) to a vitrimer, which can advantageously be thermally recycled. Complete aminolysis of PET was completed by addition of commercially available polyamines (e.g., diamines, triamines, tetraamines or higher polyamines) to bulk PET material. After addition of the polyamine, the PET was upcycled into vitrimer by incorporation of crosslinkers which promoted dynamic bond formation. Here, the upcycled bulk material can be solubilized to form sheets of plastic which have the potential for injection molding, vacuum forming, synthetic adhesives, and generation of filaments for 3D-printing. By fine tuning both the polyamine utilized during aminolysis and the crosslinker used during vitrimer synthesis, the material properties of the resulting plastic can be controlled. The aminolysis and conversion of PET to vitrimer, as described above, advantageously provides a way for existing bulk plastic to become part of a closed-loop (circular) plastic recycling system. The close-loop system can advantageously prevent plastic from entering the environment on an indefinite basis over the long term.

Vitrimers, or polymer networks crosslinked with dynamic bonds, are of great interest due to their thermal processibility and chemical recyclability. After use, vitrimer materials can either be thermally upcycled into new materials, or chemically degraded back to starting materials for use in new plastic goods. These properties permit used vitrimer products to be reintegrated into the plastic cycle and used in new materials. Furthermore, because of their high chemical recyclability, one vitrimer material with a given set of thermal and mechanical properties (e.g., for use as an adhesive material) can be reconstituted with a new crosslinker to adjust the properties of the polymer network to make it better suited for a new application, such as a structural composite material. While some vitrimer materials are being synthesized with new starting materials, converting already existing plastic waste into vitrimer could help both reduce plastic waste and establish plastic circularity within consumer markets.

The current research market for plastic upcycling largely focuses on the use of newly synthesized monomers. These monomers are usually chemically tailored to make them ideal targets for chemical recyclability, either by incorporating chemical targets for degradation or by tuning the structure of the monomer in a manner which controls the thermal and mechanical properties of the resulting polymer. However, after converting the monomers to plastic, the resulting plastic waste is often burned as a conventional method for eliminating plastic waste. While this is a solution to the waste buildup of plastic products in the ocean and landscape, the burning of petroleum-based oligomer and monomer byproducts of current chemical recycling contributes substantially to climate change. In contrast to the conventional approach, the approach described here can convert existing PET and other condensation-based polymers into easily recyclable vitrimer polymers that will remain within a circular plastic economy. When combined with crosslinkers, the consumable products will form new crosslinked networks that have highly controllable mechanical and thermal properties. In some cases, the present method can control Tg and moduli through changes in the chemical structure of the crosslinker as well as by modifying the crosslinking density of the resultant bulk polymer network. Thus, the presently described process can advantageously convert end-of-life commercial plastic products, which would normally inhabit landfills, into highly processible and infinitely recyclable plastics.

The vitrimer products described herein have a number of advantages, such as the following:

1. High Thermal Reprocessibility: By virtue of the dynamic bonds introduced into the upcycled vitrimer, the resultant polymer can be healed and reshaped by application of heat. This is particularly useful with vacuum molding and injection molding of plastics. As an example, the upcycled vitrimer product (such as from PET) can be molded into a bottle and after disposal can be easily heat-pressed for use as a plastic container or a plastic bag.

2. Chemical Recyclability: Many thermoset polymers used for commercial products are very difficult to recover since they have many covalent crosslinks and low solubility. In addition to being thermally reprocessible, the upcycled vitrimer product can also be easily chemically recycled back to the starting macromonomers at about 80° C. (or perhaps 60-100° C.) with an excess of amine. In some embodiments, the vitrimer is re-crosslinked to change the mechanical properties of the original polymer to make it suited for a new application.

3. Healing and Shape Recovery: Unlike many of the currently used polymers, vitrimers have the ability to self-heal, which increases the lifetime of the plastic products. Ideally, under application of low heat, polymer products can be quickly repaired without the need for complete recycling or thermal annealing.

4. Tough and Recoverable Composites: The vitrimer described here contain good mechanical properties that can be tuned by the linker structure within the crosslinker in addition to the percentage of crosslinker included in the polymer network. When combined with existing materials, such as carbon fiber, the resulting composite is often tougher than either individual material. Furthermore, because of the benefits described above, both vitrimer and carbon fiber can be recovered at the end-of-life of the composite to either regenerate the composite or use the recovered byproducts for new materials.

5. Stimuli-Responsive Adhesives: The curing reaction between the upcycled PET (aminated) macromonomer and the vitrimer crosslinkers results in an adhesive with strong bonds at room temperature and below to a number of substrates. To remove the adhesive, either acidic solution or heat can be applied to break down the bond.

6. Improved Solubility Effects: PET prior to aminolysis has low solubility in most solvents, which is a hindrance when attempting to recycle PET products. However, after aminolysis with commercially available polyamines, the solubility of the resultant aminated product can be controlled so that the aminated PET is capable of dissolution in a range of solvents. The aminolysis products described herein may be soluble in, for example, tetrahydrofuran, methanol, and acetone, among others. After crosslinking to produce the vitrimer, the resultant products show good solvent resistance with such solvents as acetone, methanol, tetrahydrofuran, toluene, and water.

In addition to adhesives, the upcycled products may be used to produce tough and recoverable composites. Various ratios of monomer to crosslinker as well as a wide variety of crosslinkers may be used to tune the properties of the resulting composite. Glass fiber, carbon fiber, silica nanoparticles, cellulose fibers, as well as glass/carbon nanoparticles or nanofibers may be used with any of the vitrimer matrices described above to form a unique composite. Moreover, vitrimer composites containing carbon fibers or particles have the potential to be electrically conductive in addition to being mechanically robust.

### BRIEF DESCRIPTION OF THE FIGURES

FIG. 1. Schematic showing where post-consumer PET waste, sourced from materials like plastic bottles and textiles, was successfully deconstructed into PET macromonomers via aminolysis using a commercially available amine (e.g., Jeffamine™). The PET macromonomer was dynamically crosslinked with acetoacetate crosslinkers to produce robust, closed-loop recyclable vitrimer plastics. This work demonstrates a catalyst- and solvent-free approach to chemical recycling of mixed PET waste streams to formulate value-added vitrimer plastics and CF/GF reinforced polymer composite materials.

FIGS. 2A-2D. FIG. 2A shows a reaction scheme of PET plastic deconstruction into PET macromonomer via aminolysis with Jeffamine™ derivatives including T-403 (JAT403) and D230. FIG. 2B has a kinetic plot showing conversion of PET waste into macromonomer with 100% conversion after 7 h. FIG. 2C contains images demonstrating deconstruction of PET plastics and textiles containing dyes and additives. A colored PET body-care bottle, mixed plastic water bottle, 60% cotton/40% PET textile, and 100% PET textile, were selectively deconstructed in the presence of dyes and additives. The dyes and other components were removed during precipitation of the monomer and remained in the aqueous layer. FIG. 2D is a schematic showing the process for combining the acetoacetate crosslinker and PET macromonomer into vinylogous urethane dynamic bond containing vitrimer.

FIGS. 3A-3I. FIG. 3A shows the FTIR spectrum for both the PET macromonomer and cured TCD-V film. The disappearance of the characteristic C═O ester and C═O ketone bands of the acetoacetate crosslinkers after the reaction confirms the formation of vinylogues urethane vitrimer. FIG. 3B shows the DSC curves for the three vitrimers (TCD-V, DCH-V, and Hex-V) with an Amine: AcAc ratio of 10:7 with labeled glass transition temperatures. These values represent glass transition temperatures and align well with the values from DMA. FIG. 3C shows the DMA measurements (amplitude, 15 μm; frequency, 1 Hz; T ramp rate, 3° C./min) of three vitrimers with an Amine: AcAc ratio of 10:7 showing the storage moduli and rubbery plateau. FIG. 3D shows the tand for each tested vitrimer films, extrapolated from DMA measurements. FIG. 3E shows the tensile stress-strain curves for the TCD-V, DCH-V, and Hex-V with an Amine: AcAc ratio of 10:7, compared to commercial PET (Egg carton film). FIG. 3F shows the average tensile stress and Young's modulus for each of the tested vitrimer films and commercial PET. The tensile strength of TCD-V and DCH-V significantly outperform commercial PET. All error bars represent the SD with at least three replicates. FIG. 3G shows the representative stress-strain curve of TCD-V vitrimers with different crosslinked density. FIG. 3H shows the stress-strain curves of DCH-V vitrimers with different crosslinked density. FIG. 3I shows the stress-strain curves of Hex-V vitrimers with different crosslinked density.

FIGS. 4A-4H. FIG. 4A shows the shear moduli vs frequency plotted for the 10:7 TCD-V. FIG. 4B shows the shear modulus plotted against time for increasing temperatures of the 10:7 TCD-V. As shown, the shear modulus decreases at an accelerating rate with increasing temperature. FIG. 4C shows the relaxation time for the 10:7 TCD-V, 10:7 DCH-V, and 10:7 Hex-V against inverse temperature. FIG. 4D shows the cartoon showing process of dynamic vinylogous urethane bond rearrangement when heat is applied above the Tg of the vitrimer network. FIG. 4E shows the tensile stress and strain curves for the 10:7 TCD-V film after being re-pressed three times at 200° C. and 500 psi. Here, REC 0 is the as-synthesized film and REC 3 has been cut and hot-pressed a total of 3 times. FIG. 4F shows a series of images showing how the shape memory behavior of the 10:7 TCD-V film. The film can be fixed into a new shape through elevation above the Ts for 30 seconds followed by applied force and cooling. A series of images showing the reprogrammable behavior of the 10:7 TCD-V. The initial state (shape A) is the original state, but elevation above Tg for 16 h reprograms the film to a new, lowest energy state (shape B). This process can be repeated several times-here the curl, Shape B, is converted back to the flat film (Shape C). FIG. 4G shows a series of images showing how shape memory behaviors can be used to conduct work in a stimuli-responsive manner. A vial of sand is lifted after applying heat to “grab” the hook with the 10:7 TCD-V. FIG. 4H shows consecutive cycles of shape memory behavior.

FIGS. 5A-5K. FIG. 5A schematically shows the chemical recycling of a used vitrimer film (10:7 TCD-V) using excess dodecylamine at 150° C. FIG. 5B shows the ‘H NMR of recovered PET JAT403 macromonomer after chemical recycling of TCD-V film. The 1H NMR of the recovered macromonomer is in good agreement with the virgin PET macromonomer from pure PET sources (e.g., PET Pellets). FIG. 5C is an image showing chemical recycling in the presence of mixed plastics: polypropylene (PP), polyethylene (PE), polystyrene (PS), and butadiene rubber (BR). The non-vitrimer plastics and PET macromonomer were recovered from the reaction. FIG. 5D shows the unidirectional tensile stress-strain curve of 10:7 TCD-V based GFRV compared with epoxy-based control GFRP composite. FIG. 5E shows a bar graph showing average values for UTS and Young's modulus of GFRV composite compared to an epoxy GFRP control. FIG. 5F has an image showing chemical recycling process of 10:7 TCD-V GFRV composite, pristine GFRV composite sheet, and recovered GF sheet after chemical recycling. FIG. 5G shows the SEM images of GF before and after chemical recycling show no damage to the fibers after chemical recycling. FIG. 5H shows the unidirectional tensile stress-strain curve of 10:7 TCD-V based CFRV compared with epoxy-based control CFRP composite. FIG. 5I is a bar graph showing average values for UTS and Young's modulus of CFRV composite compared to an epoxy CFRP control. FIG. 5J is an image showing chemical recycling process of 10:7 TCD-V CFRV composite, pristine CFRV composite sheet, and recovered CF sheet after chemical recycling. FIG. 5K shows the SEM images of CF before and after chemical recycling show no damage to the fibers after chemical recycling. All error bars represent the SD with at least three replicates.

FIG. 6 shows that mussel adhesive proteins, composed of amphiphilic catecholamine and lysine, form robust dynamic interactions with diverse surfaces. The amphiphilic nature of these amino acids is critical for their adaptability by providing adhesion in both wet and dry environments. Inspired by this natural system, the present disclosure has developed a tough, reversible, highly adaptable and sustainable adhesive from PET consumer waste suitable for underwater, structural, and pressure-sensitive applications. Reproduced image is copyright free and provided by Unsplash (website).

FIGS. 7A-7E. FIG. 7A is a scheme showing the deconstruction of consumer PET via aminolysis with Jeffamine™ T-403 to yield an amphiphilic, tetraamine macromonomer.

FIG. 7B is a schematic showing the process of combination of the PET-JAT403 and TCDAcAc to yield a polymer network with vinylogous urethane bonds at the crosslink junctures. Vinylogous urethane networks undergo thermally-induced transamination exchange reactions (associative exchange), where a free amine within the polymer network reacts with the vinylogous urethane bond, which provides reversibility and reprocessability. FIG. 7C shows dynamic mechanical analysis (DMA) results of bulk 10:5 TCD-V. The results revealed a high storage modulus below the glass transition temperature (T_{g}), a sharp decrease above T_{g}, and a well-defined rubbery plateau at higher temperatures, indicative of a crosslinked network. FIG. 7D shows the stress relaxation behaviors of 10:5 TCD-V over a temperature range of 493-463 K with an interval of 5 K. The shear modulus decreased at an accelerating rate with increasing temperature. FIG. 7E shows analysis of the relaxation time for the 10:5 TCD-V sample as a function of inverse temperature revealed a linear Arrhenius relationship, yielding an activation energy of 275 KJ/mol.

FIGS. 8A-8G. FIG. 8A shows how the adhesive was applied to the substrates and they were joined together underwater. The assembled joint, self-supporting immediately after bonding, was allowed to cure underwater for 16 h in room temperature. FIG. 8B shows the force-extension curves showing the underwater adhesive performance of the 10:7 TCD-V after curing for 16 h in RT water. FIG. 8C shows the lap shear strength of the 10:7 TCD-V relative to curing time. FIG. 8D shows the lap-shear strengths for varying amine: AcAc of the TCD-V after underwater curing at RT. The 10:7 formulation showed the highest adhesion with a lap-shear strength of 6.51 MPa. FIG. 8E shows the work of debonding values for various amine: AcAc ratios of the TCD-V adhesive. FIG. 8F shows the lap-shear strengths for underwater adhesion of TCD-V to different substrates. Adhesive strength was directly correlated with the hydrophilicity of the surface where less hydrophilic substrates showed greater lap-shear strengths. FIG. 8G shows the force-extension bars for the 10:7 TCD-V and controls where PET-JAT403 was replaced with JAT403 (TCD-JAT403) and TCDAcAc was replaced with EGAcAc (EG-V).

FIGS. 9A-9I. FIG. 9A shows the force-extension curve for the 10:7 TCD-V adhesive cured at RT shown with the average lap shear strength. FIG. 9B is a plot showing lap-shear strength as a function of curing time at 80° C. The RT curing lap shear strength data was also plotted to visualize the difference between 80° C. and RT. FIG. 9C is a bar graph showing lap-shear strengths for varying amine: AcAc ratios of the TCD-V adhesives compared with a 10:7 JAT403 control (JAT403) and a 10:7 EGAcAc control (EG-V). FIG. 9D shows the force vs extension curves demonstrated strong-ductile (tough) adhesion. The shaded area is marked as the area used to calculate work of debonding. FIG. 9E shows the lap-shear strength for the liquid 10:5 TCD-V adhesive for four different substrates. Those marked with a white star showed substrate failure and are therefore not indicative of the adhesive strength. FIG. 9F shows the lap-shear strength for the dry film of 10:5 TCD-V adhesive (hot-melt adhesive, HMA) for three different substrates. FIG. 9G shows the lap-shear strength for the 10:5 adhesive in extreme environments is shown. Relative humidity of 100% (RH 100) describes the results from the substrate being fully submerged in water for 24 h. FIG. 9H is an image showing thermal debonding and facile removal of adhesive from the surface at 80° C. FIG. 9I shows the rebonding ability tests for 10:5 TCD-V adhesive. The plot shows no significant change in lap-shear strength even after 10 adhesion cycles. The cartoon inset shows the process for re-adhesion (hot pressing at 120° C.). All error bars represent the SD (N=3).

FIGS. 10A-10F. FIG. 10A is a series of images showing pressure-sensitive adhesion of TCD-V (10:0.5) with teflon, paper, polycarbonate, glass, steel, and wood. FIG. 10B is an image showing a load-bearing capability where a 144 mm2 lap joint of the TCD-V PSA holds a 2.5 kg metal weight. FIG. 10C shows the lap-shear strength of the TCD-V PSA on six different common substrates. The strongest adhesion was seen on aluminum with a lap-shear strength of 50.2 kPa. FIG. 10D shows the lap-shear strength of PSA over 10 cycles of breaking and repressing of the lap joint. Adhesion is maintained with no losses over a period of 10 cycles. FIG. 10E shows the molecular structure of a TCDAcAc model molecule on a model silica surface. DFT calculations confirmed that multiple H-bonds can form between TCD-V and hydroxylated surfaces. FIG. 10F is a cartoon showing the proposed mechanism for adhesion between the TCD-V network and the substrates. Hydroxyl groups on the surface of the substrates can interact with carbonyl, amide, and primary amines of the TCD-V through H-bonding. All error bars represent the SD (N=3).

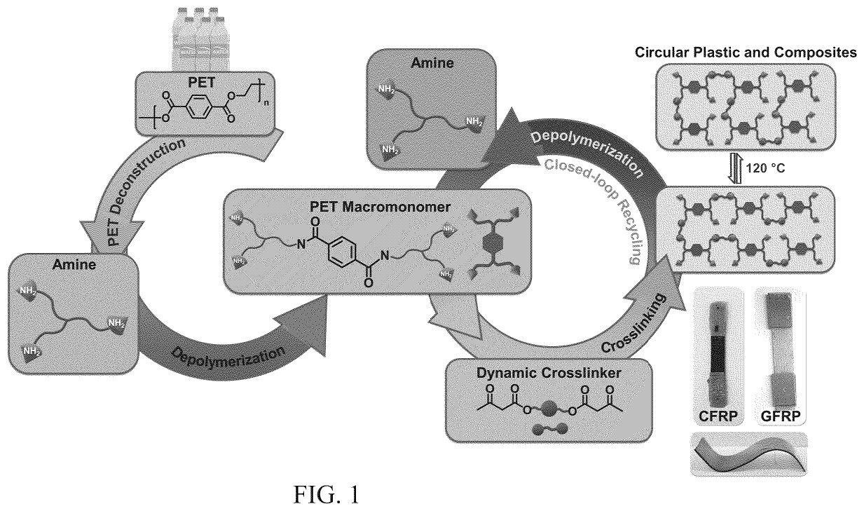

### DETAILED DESCRIPTION

As used herein, the term “hydrocarbon group” (also denoted by the group R) is defined as a chemical group composed of at least carbon and hydrogen. The term “group” indicates the absence of a hydrogen atom in order for the group to form a single covalent bond. The group may also be considered a mono-radical. In some embodiments, the hydrocarbon group is composed solely of carbon and hydrogen. In other embodiments, the hydrocarbon group may (i.e., optionally) be substituted with one or more fluorine atoms to result in partial or complete fluorination of the hydrocarbon group. In other embodiments, as further discussed below, the hydrocarbon group may contain one or more other heteroatoms (e.g., O, N, S, B, or Si) or heteroatom-containing groups. The term “hydrocarbon linker,” as also used herein, corresponds to a diradical that can be derived from any of the hydrocarbon groups described herein by removing an additional hydrogen atom from the hydrocarbon group. For example, a methylene (—CH₂—) linker can be derived from a methane (—CH₃) group by removal of an additional hydrogen atom from the methyl group.

The hydrocarbon group (R) or linker may contain at least or greater than 1, 2, 3, 4, 5, or 6 carbon atoms and up to any number of carbon atoms, such as 10, 20, 30, 40, 50, 60, 70, 80, 90, or 100 carbon atoms. In some embodiments, R or a linker thereof may be polymeric and may thus contain more than 100 carbon atoms. In some embodiments, R or a linker thereof contains 1-50 carbon atoms. In different embodiments, one or more of the hydrocarbon groups may contain, for example, 1, 2, 3, 4, 5, 6, 7, 8, 9, 10, 12, 15, 18, 20, 22, 24, 26, 28, 30, 40, or 50 carbon atoms, or a number of carbon atoms within a particular range bounded by any two of the foregoing carbon numbers (e.g., 1-50, 2-50, 3-50, 4-50, 5-50, 6-50, 1-40, 2-40, 3-40, 4-40, 5-40, 6-40, 1-30, 2-30, 3-30, 4-30, 5-30, 6-30, 1-20, 2-20, 3-20, 4-20, 5-20, 6-20, 1-12, 2-12, 3-12, 4-12, 5-12, or 6-12 carbon atoms). Hydrocarbon groups or linkers in different compounds described herein, or in different positions of a compound, may possess the same or different number (or preferred range thereof) of carbon atoms in order to independently adjust or optimize properties of the compound.

In a first set of embodiments, the hydrocarbon group (R) is a saturated and straight-chained group, i.e., a straight-chained (linear) alkyl group. Some examples of straight-chained alkyl groups include methyl, ethyl, n-propyl, n-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-eicosyl, n-docosyl, n-tetracosyl, n-hexacosyl, n-octacosyl, and n-triacontyl groups, as well as those containing 40, 50, or more carbon atoms. Examples of corresponding linkers can be derived from any of the foregoing groups by removal of an additional hydrogen atom to form a diradical (e.g., methyl converts to methylene, and ethyl converts to ethylene).

In a second set of embodiments, the hydrocarbon group (R) is saturated and branched, i.e., a branched alkyl group. Some examples of branched alkyl groups include isopropyl (2-propyl), isobutyl (2-methylprop-1-yl), sec-butyl (2-butyl), t-butyl (1,1-dimethylethyl-1-yl), 2-pentyl, 3-pentyl, 2-methylbut-1-yl, isopentyl (3-methylbut-1-yl), 1,2-dimethylprop-1-yl, 1,1-dimethylprop-1-yl, neopentyl (2,2-dimethylprop-1-yl), 2-hexyl, 3-hexyl, 2-methylpent-1-yl, 3-methylpent-1-yl, isohexyl (4-methylpent-1-yl), 1,1-dimethylbut-1-yl, 1,2-dimethylbut-1-yl, 2,2-dimethylbut-1-yl, 2,3-dimethylbut-1-yl, 3,3-dimethylbut-1-yl, 1,1,2-trimethylprop-1-yl, 1,2,2-trimethylprop-1-yl, isoheptyl, isooctyl, and the numerous other branched alkyl groups having up to 20, 30, 40, 50, or more carbon atoms, wherein the “1-yl” suffix represents the point of attachment of the group. Examples of corresponding linkers can be derived from any of the foregoing groups by removal of an additional hydrogen atom to form a diradical.

In a third set of embodiments, the hydrocarbon group (R) is saturated and cyclic, i.e., a cycloalkyl group. Some examples of cycloalkyl groups include cyclopropyl, cyclobutyl, cyclopentyl, cyclohexyl, cycloheptyl, and cyclooctyl groups. The cycloalkyl group can also be a polycyclic (e.g., bicyclic) group by either possessing a bond between two ring groups (e.g., dicyclohexyl) or a shared (i.e., fused) side (e.g., decalin and norbornane). Examples of corresponding linkers can be derived from any of the foregoing groups by removal of an additional hydrogen atom to form a diradical.

In a fourth set of embodiments, the hydrocarbon group (R) is unsaturated and straight-chained, i.e., a straight-chained (linear) olefinic or alkenyl group. The unsaturation occurs by the presence of one or more carbon-carbon double bonds and/or one or more carbon-carbon triple bonds. Some examples of straight-chained olefinic groups include vinyl, propen-1-yl (allyl), 3-buten-1-yl (CH₂═CH—CH₂—CH₂—), 2-buten-1-yl (CH₂—CH—CH—CH₂—), butadienyl, 4-penten-1-yl, 3-penten-1-yl, 2-penten-1-yl, 2,4-pentadien-1-yl, 5-hexen-1-yl, 4-hexen-1-yl, 3-hexen-1-yl, 3,5-hexadien-1-yl, 1,3,5-hexatrien-1-yl, 6-hepten-1-yl, ethynyl, propargyl (2-propynyl), 3-butynyl, and the numerous other straight-chained alkenyl or alkynyl groups having up to 20, 30, 40, 50, or more carbon atoms. Examples of corresponding linkers can be derived from any of the foregoing groups by removal of an additional hydrogen atom to form a diradical.

In a fifth set of embodiments, the hydrocarbon group (R) is unsaturated and branched, i.e., a branched olefinic or alkenyl group. Some examples of branched olefinic groups include propen-2-yl (CH₂═C—CH₃), 1-buten-2-yl (CH₂═C—CH₂—CH₃), 1-buten-3-yl (CH₂═CH—CH—CH₃), 1-propen-2-methyl-3-yl (CH₂═C (CH₃)—CH₂—), 1-penten-4-yl, 1-penten-3-yl, 1-penten-2-yl, 2-penten-2-yl, 2-penten-3-yl, 2-penten-4-yl, and 1,4-pentadien-3-yl, and the numerous other branched alkenyl groups having up to 20, 30, 40, 50, or more carbon atoms, wherein the dot in any of the foregoing groups indicates a point of attachment. Examples of corresponding linkers can be derived from any of the foregoing groups by removal of an additional hydrogen atom to form a diradical.

In a sixth set of embodiments, the hydrocarbon group (R) is unsaturated and cyclic, i.e., a cycloalkenyl group. The unsaturated cyclic group may be aromatic or aliphatic. Some examples of unsaturated cyclic hydrocarbon groups include cyclopropenyl, cyclobutenyl, cyclopentenyl, cyclopentadienyl, cyclohexenyl, cyclohexadienyl, phenyl, benzyl, cycloheptenyl, cycloheptadienyl, cyclooctenyl, cyclooctadienyl, and cyclooctatetraenyl groups. The unsaturated cyclic hydrocarbon group may or may not also be a polycyclic group (such as a bicyclic or tricyclic polyaromatic group) by either possessing a bond between two of the ring groups (e.g., biphenyl) or a shared (i.e., fused) side, as in naphthalene, anthracene, phenanthrene, phenalene, or indene fused ring systems. Examples of corresponding linkers can be derived from any of the foregoing groups by removal of an additional hydrogen atom to form a diradical (e.g., phenyl converts to phenylene).

As indicated earlier above, any of the hydrocarbon groups described above may be substituted with one or more fluorine atoms. As an example, an n-octyl group may be substituted with a single fluorine atom to result in, for example, a 7-fluorooctyl or 8-fluorooctyl group, or substituted with two or more fluorine atoms to result in, for example, 7,8-difluorooctyl, 8,8-difluorooctyl, 8,8,8-trifluorooctyl, or perfluorooctyl group. Any of the hydrocarbon groups described herein may contain a single ether (—O—) or thioether (—S—) linkage connecting between carbon atoms in the hydrocarbon group. An example of a hydrocarbon group containing a single ether or thioether group is —(CH₂)₂—X—(CH₂) 7CH₃, wherein X represents O or S.

As further indicated earlier above, any of the hydrocarbon groups described above may be substituted with one or more heteroatom-containing groups. Some examples of heteroatom-containing groups include —OH, —OR″, —NH₂, —NHR″, —NR″₂, —NO₂, —SR″, —SO₂R″, —SO₂NR″₂, —C(O)R″, —C(O)OR″, —C(O)NH₂, —C(O) NHR″, —C(O)NR″₂, —C(S)OR″, —C(O)SR″, —C(S)NH₂, —C(S)NHR″, and —C(S)NR″₂ groups, wherein R″ groups are independently selected from alkyl groups containing 1-20 carbon atoms. In some embodiments, any one or more heteroatom-containing groups are excluded from the hydrocarbon groups. In some embodiments, the hydrocarbon group(s) is/are composed of carbon and hydrogen with the exception that they may (i.e., optionally) include one or more ether (—O—) groups, or more particularly, one or more ethyleneoxy (—CH₂CH₂O—) groups.

In a first aspect, the present disclosure is directed to a method of deconstructing and upcycling used (waste) polymeric material into at least one useful monomeric product. The term “polymeric,” as used herein, is intended to include “plastic”. Typically, the polymeric material contains carbonyl groups in the backbone of the polymer. More typically, the polymeric material is a condensation polymer. Some examples of such polymers include polyesters, polycarbonates, polyamides, and polyurethanes.

In the method, the polymeric material is reacted with a polyamine (e.g., diamine, triamine, tetraamine, or higher polyamine) molecule under conditions that result in covalent attachment of the polyamine molecule with the polymer in the polymeric material to produce an aminated monomer, wherein the aminated monomer contains a multiplicity of free unreacted amino groups from the polyamine molecule. The presence of free amines is essential to provide dynamic reversible crosslinking in the crosslinked vitrimer polymer. Particularly in the case of a polyester (e.g., PET), the reaction with the polyamine typically results in formation of an amide (—NHC(O)—) linkage between the polymer and primary amine group of the polyamine. In the case of a polycarbonate, a carbamate (—OC(O)NH—) linkage may be formed. In the case of a polyamide or polyurethane, a urea (—NHC(O)NH—) may be formed.

The polyamine molecule contains at least two or three amino groups. The polyamine molecule can be conveniently represented by the following formula:

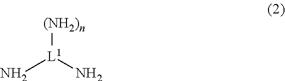

In Formula (1), the variable L¹ is independently selected, in each instance, from hydrocarbon linkers, such as any of those described above, containing at least or more than three, four, five, six, seven, eight, nine, or ten carbon atoms and optionally containing one or more heteroatoms selected from N, O, S, and Si. In some embodiments, L¹ is a hydrocarbon linker containing at least one ethylene oxide (—CH₂CH₂O—), propylene oxide (—CH(CH₃)CH₂O—), and/or ethylene imine (—CH₂CH₂NH—) linkage. More typically, the variable L¹ is independently selected, in each instance, from linear or branched alkyl linkers, such as any of those described above, containing at least or greater than three, four, five, six, seven, eight, nine, or ten carbon atoms and optionally containing one or more heteroatoms selected from N, O, S, and Si. In some embodiments, the variable L¹ is a linear or branched alkyl linker containing at least one O atom, or more particularly, L¹ is a linear or branched alkyl linker containing at least one ethylene oxide (—CH₂CH₂O—), propylene oxide (—CH(CH₃)CH₂O—), and/or ethylene imine (—CH₂CH₂NH—) linkage.

In one embodiment, the variable a is 0, in which case the polyamine of Formula (1) is a diamine. In other embodiments, the subscript a is independently, in each instance, an integer of precisely or at least 1. When subscript a is 1, the polyamine of Formula (1) is a triamine. In other embodiments, the subscript a is independently, in each instance, an integer of precisely or at least 2, 3, or 4, which results in the polyamine of Formula (1) being a tetramine, pentamine, or hexamine (or a higher amine).

Some examples of polyamine molecules include the following:

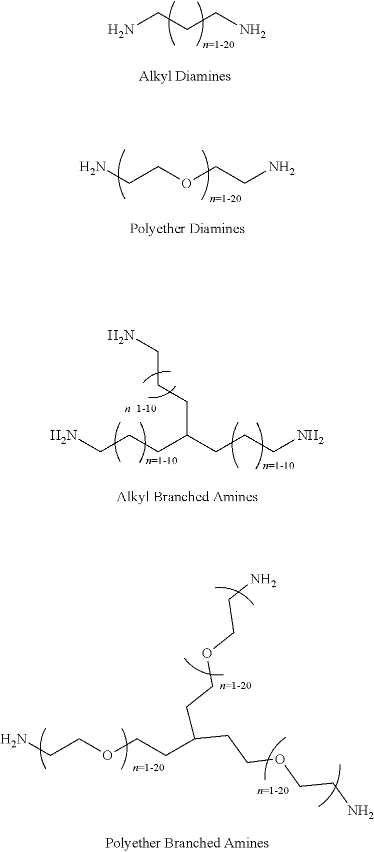

In some embodiments, the polyamine molecule is polymeric by having a polymeric L¹ portion. The polymeric L¹ portion may be linear or branched. In some embodiments, the L¹ portion is branched, with each branch containing one or a multiplicity of ethylene oxide (—CH₂CH₂O—), propylene oxide (—CH(CH₃)CH₂O—), and/or ethylene imine (—CH₂CH₂NH—) linkages. In some embodiments, the polymeric polyamine is more particularly a polyetheramine, as well known in the art. Numerous types of polyetheramines are commercially available, such as those under the JEFFAMINE™ trade name, any of which can be used as a polyamine for the purposes of the present invention. Some polyetheramines have the following formula:

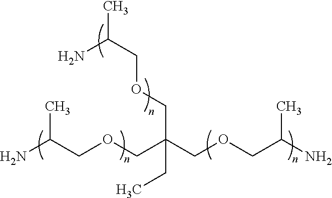

Any of the polyamines provided above are reacted with the polymeric material (e.g., PET) to form a covalent bond (e.g., amide bond) with the polymeric material. The end result is a polyaminated monomer containing a multiplicity of free amine groups. The conditions that result in covalent attachment of the polyamine to the polymeric material are typically those conditions well known in the art which facilitate the formation of an amide bond between carboxylate esters and primary amines. The temperature employed is typically below the melting point of the polymer. The temperature may be in the range of, for example, 150-200° C., and such a temperature may be maintained for a period of, for example, 6-24 hours depending on the nature of the polymer and polyamine. In some embodiments, the reaction includes a solvent in which the polymer and polyamine are soluble. In other embodiments, the reaction excludes a solvent so that the reaction is conducted with only the polymer and polyamine present. Notably, in some embodiments, the polyamine functions as a solvent. The aminated monomer is described herein primarily for its use as a precursor for producing a crosslinked vitrimer polymer. However, the aminated monomer may be used for a variety of other applications where polyamines may be useful, such as a curing agent (e.g., for an epoxy or urea polymer) or as a sizing agent for particles or fibers (e.g., carbon fibers).

In more particular embodiments, the present disclosure is directed to a method of deconstructing and upcycling polyethylene terephthalate (PET) waste into at least one useful monomeric product. The monomeric product is aminated (i.e., contains a number of primary amine groups). In the method, PET waste (1) is reacted with a polyamine molecule (2), such as any polyamine described above, under amidation conditions to produce an aminated monomer (3), according to the following reaction scheme:

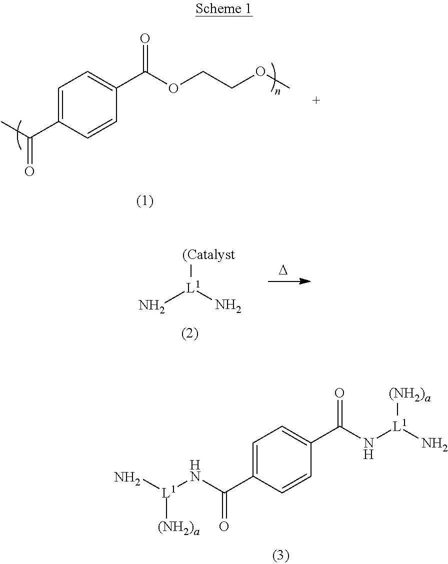

In the above scheme, Formula (1) represents PET and Formula (2) represents the polyamine as described in detail above. As PET is a polymer, the variable n represents the typical number of units, typically an average, for PET. The variable n is typically at least or greater than 20, 30, 40, 50, 100, 150, 200, 250, or 500. The variable L¹ in Formula (3) can be any of the linkers provided above for L¹ under Formula (2), wherein each instance of L¹ is independently selected, which thus permits the two instances of L¹ shown in Formula (3) to be the same or different. The variable a is as provided above under Formula (2), wherein each instance of variable a is independently selected, which thus permits the two instances of variable a to be the same or different.

The symbol Δ in the above Scheme 1 denotes an elevated temperature sufficient to promote an amidation reaction between (1) and (2) to produce the monomer (3). The elevated temperature is typically at least 150° C. and up to 250° C., provided that the temperature is below the decomposition temperature of the PET waste. In different embodiments, the temperature may be, for example, 150° C., 160° C., 170° C., 180° C., 190° C., 200° C., 210° C., 220° C., 230° C., 240° C., or 250° C., or a temperature within a range bounded by any two of the foregoing values (e.g., 150-250° C., 150-200° C., 160-250° C., 160-200° C., 170-250° C., 170-200° C., or 170-190° C.). The process may be conducted at any of the foregoing temperatures for a period of time of, for example, 1 hour, 2 hours, 4 hours, 8 hours, 16 hours, or 24 hours, or a period of time within a range therein. The method may be conducted at ambient pressure (about 1 atm) but may, in some embodiments, subject the combined components (polymer waste in contact with polyamine) to a reduced pressure (e.g., less than 1 or 0.1 atm) or an elevated pressure, e.g., above 1 atm, or at least 2, 5, 10, 20, or 50 atm.

In another aspect, the present disclosure is directed to the production of vinylogous monomers or polymers by reaction of the aminated monomer (3) with a molecule containing at least two acylacetate groups. Molecules containing at least two acylacetate groups are herein referred to as poly(acylacetate) molecules or compounds. Such molecules are shown in Formula (4) below. An acylacetate group has the formula: R¹C (O) CH₂C (O)O—, wherein the RIC (O) portion is the acyl portion and the CH₂C (O)O-portion is the acetate portion. R¹ is independently, in each instance, selected from H atom and hydrocarbon groups containing 1-3 carbon atoms. Some examples of R¹ include methyl, ethyl, n-propyl, and isopropyl.

Poly (acylacetate) molecules can be conveniently depicted by the following formula:

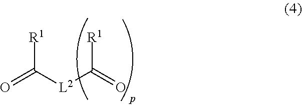

The variable R¹ in Formula (4) has been defined above. R¹ is independently, in each instance, selected from H atom and hydrocarbon groups containing 1-3 carbon atoms. Some examples of R¹ include methyl, ethyl, n-propyl, and isopropyl. The variable L² represents a hydrocarbon linker containing 1-50 carbon atoms and optionally containing one or more heteroatoms selected from N, O, S, and Si, as described in detail earlier above, wherein L² contains at least one ester-containing linkage group of the formula —CH₂C(O)O—. Any of the hydrocarbon linking groups described above under R may be selected as L². In some embodiments, L² is or includes a linear or branched alkyl linker containing at least one ester-containing linkage of the formula —CH₂C (O)O—. Typically, at least one ester-containing linkage of the formula —CH₂C(O)O— in L² is interconnected with each R¹C(O) group; thus, the number of —CH₂C(O)O-linkages in L² typically corresponds to p+1. In some embodiments, L² contains precisely or at least one or two cyclic linking groups or bicyclic (fused or linked) ring systems, wherein the cyclic linking groups or bicyclic ring systems (also linking) may be saturated or unsaturated, such as any of the hydrocarbon cyclic linking groups described above for R. The variable p is an integer of 1-5. When p is 1, the molecule of Formula (4) is a di(acylacetate); when p is 2, the molecule of Formula (4) is a tri (acylacetate); when p is 3, the molecule of Formula (4) is a tetra (acylacetate); and so on.

In some embodiments, L² is a —CH₂C(O)O—L²a —OC(O)CH₂— linkage, wherein L^{2a} is a hydrocarbon group containing 1-46 carbon atoms, such as any of those described above, and optionally containing one or more heteroatoms selected from N, O, S, and Si. In some embodiments, L^{2a} is or includes a linear or branched alkyl linkage containing 1-46 carbon atoms, such as any of those described above. In some embodiments, L^{2a} contains precisely or at least one or two cyclic groups or bicyclic (fused or linked) ring systems, wherein the cyclic groups or bicyclic ring systems may be saturated or unsaturated, such as any of the hydrocarbon cyclic linking groups described above for R.

Some particular examples of poly(acylacetate) molecules of Formula (4) along with general methods for synthesizing them are provided in the following scheme:

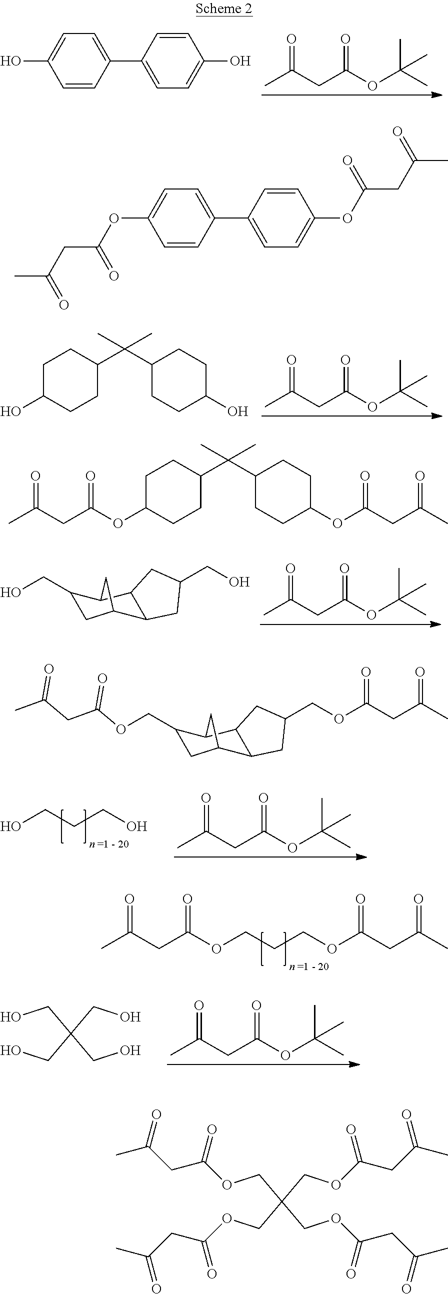

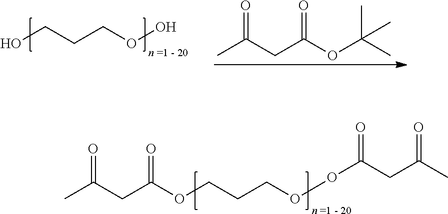

The reaction between the aminated monomer and poly(acylacetate) molecule is performed under conditions that result in reaction between a portion of the free unreacted amino groups in the aminated monomer and carbonyl groups in the bis(acylacetate) compound of Formula (4) to result in a crosslinked polymer containing vinylogous urethane covalent linkages and free unreacted primary amino groups. To ensure that the crosslinked polymer contains free unreacted primary amino groups, the molar ratio of acyl groups (in poly(acylacetate) molecules) to free primary amino groups in the aminated monomer of Formula (3) should be less than 1, and in some embodiments, around 0.3, 0.4, 0.5, 0.6, 0.7, 0.8, or 0.9, or a molar ratio within a range bounded by any two of the foregoing values (e.g., 0.3-0.9, 0.3-0.8, 0.4-0.9, 0.4-0.8, 0.5-0.9, or 0.5-0.8). The presence of free amines is essential to provide dynamic reversible crosslinking in the crosslinked vitrimer polymer. The reaction is typically conducted at room temperature with an additional curing step occurring at 80° C. to complete formation of the vinylogous urethane bonds and remove excess solvent if necessary.

As well known, a vinylogous urethane linkage has the following general structure and also interconverts between two forms, as follows:

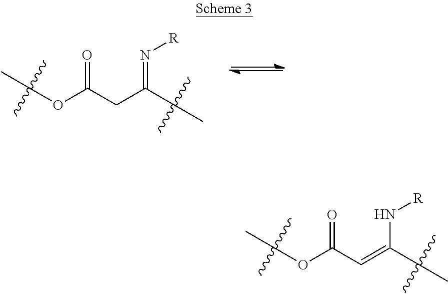

Thus, the crosslinked (vitrimer) polymer resulting from reaction of aminated monomer and carbonyl groups in the bis(acylacetate) compound of Formula (3) contains a multiplicity of vinylogous urethane linkages of the above formula.

In some embodiments, a poly(acylacetate) molecule of Formula (4) is reacted with an aminated PET monomer of Formula (3) to result in a crosslinked vitrimer polymer composed of A and B units and containing a multiplicity of vinylogous urethane linkages. The conversion of PET to the crosslinked vitrimer polymer proceeds by the following reaction process:

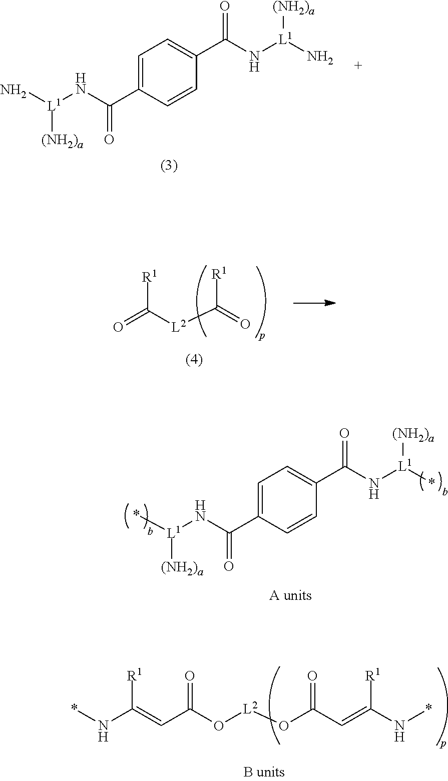

In the A and B units of the crosslinked polymer, the asterisks (*) in A units represent covalent bond connection points with asterisks in B units, and vice-versa. The variable R¹ is independently, in each instance, selected from H atom and hydrocarbon groups containing 1-3 carbon atoms, as described above. The variable L¹ is independently selected, in each instance, from hydrocarbon linkers containing at least three carbon atoms and optionally containing one or more heteroatoms selected from N, O, S, and Si, as discussed in detail above. The subscript a is independently, in each instance, an integer of at least 1; the subscript b is independently, in each instance, an integer of at least 1; and the subscript p is an integer of 1-5, all as described earlier above. The variables R¹, L¹, a, b, and p can all be independently selected from any of the definitions and exemplary embodiments provided earlier above for each of these variables.

In the above scheme, L² represents a hydrocarbon linker containing 1-50 carbon atoms and optionally containing one or more heteroatoms selected from N, O, S, and Si, as described in detail above. Typically, L² is a —CH₂C(O)O—L^{2a}—OC(O)CH₂-linkage, wherein L²a is a hydrocarbon group containing 1-46 carbon atoms, such as any of those described above, and optionally containing one or more heteroatoms selected from N, O, S, and Si. In some embodiments, L^{2a} is or includes a linear or branched alkyl linkage containing 1-46 carbon atoms, such as any of those described above. In some embodiments, L^{2a} contains precisely or at least one or two cyclic linking groups or bicyclic (fused or linked) ring systems, wherein the cyclic linking groups or bicyclic ring systems (also linking) may be saturated or unsaturated, such as any of the hydrocarbon cyclic linking groups described above for R.

In separate embodiments, the present disclosure is directed to vinylogous urethane compounds having the following formula:

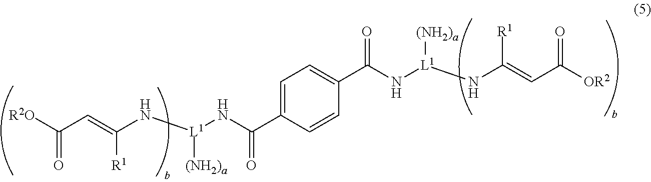

The variable R¹ in Formula (5) is independently, in each instance, selected from H atom and hydrocarbon groups containing 1-3 carbon atoms, as described above. The variable L¹ is independently selected, in each instance, from hydrocarbon linkers containing at least three carbon atoms and optionally containing one or more heteroatoms selected from N, O, S, and Si, as discussed in detail above. The subscript a is independently, in each instance, an integer of at least 1; the subscript b is independently, in each instance, an integer of at least 1; all as described earlier above. The variables R¹, L¹, a, and b can all be independently selected from any of the definitions and exemplary embodiments provided earlier above for each of these variables.

The variable R² in Formula (5) is independently, in each instance, selected from hydrocarbon groups containing at least one, two, or three carbon atoms and optionally containing one or more heteroatoms selected from N, O, S, and Si, such as any of the hydrocarbon groups described above under R. In some embodiments, R² is selected from linear or branched alkyl groups containing at least one, two, or three carbon atoms. In some embodiments, two R² groups from different molecules of Formula (5) do not interconnect, in which case the molecule of Formula (5) is a monomer. Such a monomer can result from the reaction of the aminated monomer of Formula (3) with an acylacetate molecule of the Formula (4) when p is 0 (corresponding to RIC (O) L²H). In other (optional) embodiments, two R² groups from different molecules of Formula (5) interconnect, optionally repetitively, through a hydrocarbon linker L³ containing at least one carbon atom and optionally one or more heteroatoms selected from N, O, S, and Si, in which case the molecule of Formula (5) is a polymer. In some embodiments, L³ represents a hydrocarbon linker containing 1-50 carbon atoms and optionally containing one or more heteroatoms selected from N, O, S, and Si, as described above for L². Indeed, in the case where two R² groups are linked, the R²-R² linkage corresponds to L², as described earlier above, or L³, as described above.

In some embodiments, the vitrimer polymer composition contains a filler component. The filler component is composed of particles of a desired material. If present, the particles are embedded within the vitrimer polymer composition. In some embodiments, the filler particles have an approximate or precise spherical or polygonal shape. In other embodiments, the filler particles have a fiber shape. In particular embodiments, the filler component is selected from one or a combination of ceramic particles, glass particles, carbon particles, silica particles, and biopolymer particles (e.g., wood, cellulose, lignin, or chitosan). The filler component is typically homogeneously dispersed throughout the vitrimer polymer composition. In other embodiments, the vitrimer polymer composition does not contain a filler component or any particles. The particles may be nanoparticles (e.g., at least 1, 2, 5, or 10 nm, and up to 20, 50, 100, 200, or 500 nm), microparticles (e.g., at least 1, 2, 5, or 10 μm, and up to 20, 50, 100, 200, or 500 μm), or macroparticles (e.g., above 500 μm, or at least or up to 1, 2, 5, 10, 20, 50, or 100 mm).

In one set of embodiments, the filler component contains particles having a ceramic composition (i.e., “ceramic particles”). The ceramic particles can have any of the known ceramic compositions, such as ceramic oxide, ceramic sulfide, ceramic nitride, ceramic carbide, and ceramic boride compositions. Typically, the ceramic composition includes one or more metallic and/or metalloid (main group) elements bonded with oxygen, sulfur, nitrogen, phosphorus, carbon, silicon, or boron atoms, or a combination of two or more of such atoms. The metallic elements include the alkaline earth, transition metal, and lanthanide elements, as found in Groups 2-12 of the Periodic Table. The metalloid elements include the main group metals (typically, Groups 13-15 of the Periodic Table). Thus, the ceramic composition may be, for example, an alkaline earth oxide, transition metal oxide, main group oxide, lanthanide oxide, alkaline earth sulfide, transition metal sulfide, main group sulfide, lanthanide sulfide, alkaline earth nitride, transition metal nitride, main group nitride, lanthanide nitride, alkaline earth carbide, transition metal carbide, main group carbide, lanthanide carbide, alkaline earth boride, transition metal boride, main group boride, and lanthanide boride. Particles, including nanoparticles and microparticles of any of these, are well known in the art. Moreover, the ceramic composition may correspond to a natural mineral composition, such as mullite, quartz, basalt, and clays. The ceramic composition may alternatively be a natural or synthetic zeolite. In some embodiments, any one or more types of filler particles described herein are excluded from the composition.

Some examples of ceramic oxide compositions include silica (SiO₂), alumina (Al₂O₃), titania (TiO₂), zirconia (TiO₂), yttria (Y₂O₃), hafnia (HfO₂), niobium oxide (e.g., Nb₂O₅), iron oxide (e.g., FeO, Fe₂O₃ and/or Fe₃O₄), cobalt oxide (CoO), nickel oxide (NiO), zinc oxide (ZnO), tin oxide (SnO₂), indium tin oxide, germanium oxide (GeO₂), gallium oxide (Ga₂O₃), indium oxide (In₂O₃), antimony oxide (Sb₂O₃), magnesium oxide (MgO), calcium oxide (CaO), cerium oxide (CeO₂), and lanthanum oxide (La₂O₃). In some embodiments, the ceramic oxide is silica, or more particularly, fumed silica (FS), as well known in the art. In separate or further embodiments, the ceramic oxide is or includes polyhedral oligomeric silsesquioxane (POSS) particles. In any of the foregoing examples of oxides, the oxygen (O) may be substituted with sulfur(S) to result in a corresponding ceramic sulfide. The ceramic composition may alternatively be a ceramic oxysulfide.

Some examples of ceramic nitride compositions include silicon nitride (Si₃N₄), aluminum nitride (AlN), gallium nitride (GaN), indium nitride (InN), indium gallium nitride, boron nitride (BN), titanium nitride (TiN), zirconium nitride (ZrN), and magnesium nitride (Mg₃N₂). The ceramic nitride may alternatively be a ceramic oxynitride, such as a silicon oxynitride, aluminum oxynitride, gallium oxynitride, indium oxynitride, titanium oxynitride, or zinc oxynitride. In any of the foregoing examples of oxides or oxynitrides, the nitrogen (N) can be substituted with phosphorus (P) or arsenic (As) to result in a corresponding ceramic phosphide or ceramic arsenide, such as GaP, GaAs, InP, InAs, and InGaAs.

Some examples of ceramic carbide compositions include silicon carbide (SIC), titanium carbide, zirconium carbide, tungsten carbide, and boron carbide. In any of the foregoing examples other than SiC, the carbon (C) may be replaced with silicon (Si) to result in a ceramic silicide, such as magnesium silicide and molybdenum disilicide. Notably, for purposes of this invention, the term “ceramic carbide” is understood to not include carbon particles.

Some examples of ceramic boride compositions include aluminum boride, magnesium boride, titanium boride, zirconium boride, yttrium boride, tantalum boride, molybdenum boride, and tungsten boride. In any of the foregoing examples other than aluminum boride, the boron (B) may be replaced with aluminum (Al) to result in a ceramic aluminide, such as boron aluminide, magnesium aluminide, titanium aluminide, yttrium aluminide, zirconium aluminide, iron aluminide, and nickel aluminide.

In another set of embodiments, the filler component contains particles having a carbon composition (i.e., “carbon particles”). The carbon particles may be in place of or in combination with ceramic particles. The carbon particles, if present, can be any of the carbon particles known in the art that are composed substantially of elemental carbon. Some examples of carbon particles include carbon black (“CB”), graphene, graphene oxide, graphene nanoribbons, carbon onion (“CO”), a spherical fullerene (e.g., buckminsterfullerene, i.e., C₆₀, as well as any of the smaller or larger buckyballs, such as C₂₀ or C₇₀), a tubular fullerene (e.g., single-walled, double-walled, or multi-walled carbon nanotubes), carbon nanodiamonds, and carbon nanobuds, all of which have compositions and physical and electrical properties well-known in the art. As known in the art, fully graphitized carbon nanodiamonds can be considered to be carbon onions. In some embodiments, the filler component excludes carbon particles.

In some embodiments, the carbon particles are composed solely of carbon. In other embodiments, the carbon particles are doped with one or a combination of non-carbon non-hydrogen (i.e., hetero-dopant) elements, such as nitrogen, oxygen, sulfur, boron, silicon, or phosphorus. The amount of doping element is often a minor amount (e.g., up to 0.1, 0.5, 1, 2, or 5 wt. % or mol %) but may be significantly higher (e.g., at least 5, 10, or 20 mol %), particularly in the case of oxygen as dopant. In some embodiments, the carbon particles are selected from graphene, graphene oxide, or a combination thereof. Graphene oxide can have 5-30% heteroatom (oxygen) content. In some embodiments, highly oxidized (oxygen content up to 50%) graphene oxide is used as carbon-based particle. In some embodiments, any one or more of the specifically recited classes or specific types of carbon particles are excluded, or any one or more of the specifically recited classes or specific types of hetero-dopant elements are excluded from the carbon particles.

In some embodiments, the carbon particles can be any of the high strength carbon fiber compositions known in the art. As known in the art, the carbon fiber has its length dimension longer than its width dimension. Carbon fibers can be relatively short (e.g., 1-10 cm) or typical length (e.g., 0.1 m, 1 m, or longer). Some examples of carbon fiber compositions include those produced by the pyrolysis of polyacrylonitrile (PAN), viscose, rayon, pitch, lignin, polyolefins, as well as vapor grown carbon nanofibers, any of which may or may not be heteroatom-doped, such as with nitrogen, boron, oxygen, sulfur, or phosphorus. The carbon fiber typically possesses a high tensile strength, such as at least 500, 1000, 2000, 3000, 5000, 7,000, or 10,000 MPa, or higher, with a degree of stiffness generally of the order of steel or higher (e.g., 100-1000 GPa). The carbon particles may also be chopped versions of a carbon fiber, typically having lengths within a range of 10-1000 microns. In some embodiments, carbon fibers or particles derived therefrom are excluded from the composition.

In some embodiments, the particles of the filler have an average primary particle size in the range of 1-100 nm. In different embodiments, the particles of the filler have an average primary particle size of precisely or about, for example, 1, 2, 5, 10, 15, 20, 25, 30, 35, 40, 45, 50, 60, 65, 70, 75, 80, 85, 90, 95, or 100 nm, or a particle size within a range bounded by any two of the foregoing values (e.g., 1-100 nm, 1-80 nm, 1-50 nm, 1-40 nm, 1-30 nm, 1-20 nm, 1-10 nm, 1-5 nm, 2-50 nm, 2-40 nm, 2-30 nm, 2-20 nm, 2-10 nm, 2-5 nm, 5-100 nm, 5-80 nm, 5-50 nm, 5-20 nm, or 5-10 nm). The particle size range, which may be any of the foregoing exemplary ranges, may be monomodal, bimodal, or higher modal, and each mode (distribution) may have a peak particle size corresponding to any of the particle sizes provided above.

The ceramic or carbon particles may or may not agglomerate or arrange themselves into micron-length structures. In some embodiments, the ceramic or carbon particles may be referred to as “high structure particles”, which indicates an ability of the particles to assemble into linear or branched or hierarchically beaded or necklace-like clustered structures, typically in the micron-length range. The term “micron-length”, as used herein, typically refers to a length of at least 500 nm, 1000 nm, 2000 nm, 3000 nm, 4000 nm, or 5000 nm, or a length within a range bounded by any two of these values. As known in the art, the structure of particles typically influences both dispersion and flocculation of the particles in a polymer matrix [Yu, J., L. Q. Zhang, M. Rogunova, J. Summers, A. Hiltner, and E. Baer. “Conductivity of polyolefins filled with high-structure carbon black.” Journal of applied polymer science 98, no. 4 (2005): 1799-1805.] As well known, fumed silica or fumed alumina can behave as high structure particles [Uchino, T., et al. (2004). Microscopic structure of nanometer-sized silica particles. Physical Review B, 69 (15), 155409].

The ceramic particles or carbon particles may or may not be surface functionalized. In one set of embodiments, the ceramic or carbon particles are not surface functionalized (i.e., they are bare). In another set of embodiments, the ceramic or carbon particles are surface functionalized. The surface functionalization may be provided by discrete surface functional groups or polymers. The surface functional groups may be, for example, hydroxy, carboxy, amine, epoxy, or thiol groups, or an alkyl or alkenyl chain (or surfactant) containing one or more of any of the foregoing groups. The surface functional polymer may be, for example, a polysiloxane, polyether, polyamine (such as the polyamine monomer of Formula (3), or polyimine. Particles containing different functional groups may also be used. In some embodiments, any one or more of the foregoing surface functional groups may be excluded from the ceramic or carbon particles while one or more other types may be included.

The filler component (e.g., ceramic particles, carbon particles, biopolymers, or combination thereof) is typically present in the polymer material in an amount of at least 0.1 wt. % and up to 10 wt. % by weight of components (i) and (ii). In different embodiments, the filler component is present in an amount of precisely, about, or at least, for example, 0.1 wt. %, 0.2 wt. %, 0.5 wt. %, 1 wt. %, 1.5 wt. %, 2 wt. %, 2.5 wt. %, 3 wt. %, 3.5 wt. %, 4 wt. %, 4.5 wt. %, 5 wt. %, 5.5 wt. %, 6 wt. %, 6.5 wt. %, 7 wt. %, 7.5 wt. %, 8 wt. %, 8.5 wt. %, 9 wt. %, 9.5 wt. %, or 10 wt. %, or an amount within a range bounded by any two of the foregoing values, e.g., 0.1-10 wt. %, 0.1-8 wt. %, 0.1-5 wt. %, 0.1-4 wt. %, 0.1-3 wt. %, 0.5-10 wt. %, 0.5-8 wt. %, 0.5-5 wt. %, 0.5-4 wt. %, 0.5-3 wt. %, 1-10 wt. %, 1-9 wt. %, 1-8 wt. %, 1-7 wt. %, 1-6 wt. %, 1-5 wt. %, 1-4 wt. %, 1-3 wt. %, 1-2 wt. %, 2-10 wt. %, 2-9 wt. %, 2-8 wt. %, 2-7 wt. %, 2-6 wt. %, 2-5 wt. %, 2-4 wt. %, or 2-3 wt. %.

In another aspect, the present disclosure is directed to a method of bonding (adhering) first and second surfaces together by use of any of the above described crosslinked vitrimer polymer compositions composed of A and B units. In some embodiments, each L¹ contains at least one —CH₂CH₂O—or —CH(CH₃)CH₂O—linkage. In other embodiments, L² contains a cyclic linking group. As the polymer composition functions to adhere surfaces together, the polymer composition may be referred to as an adhesive. In the method, the polymer composition is placed (applied) between the first and second adherent surfaces and the surfaces are hot pressed at a temperature of 80° C. to 200° C. In different embodiments, the applied temperature may be precisely or about, for example, 80° C., 90° C., 100° C., 120° C., 150° C., 180° C., or 200° C., or a temperature within a range bounded by any two of the foregoing values (e.g., 80-180° C., 80-150° C., 80-120° C., 100-180° C., 100-150° C., or 100-120° C.). The first and second surfaces may be the same or different and may be selected from, for example, metal surfaces (e.g., steel or aluminum), ceramic surfaces (e.g., cement, concrete, cinder block, or brick), glass surfaces, polymer matrix composite surfaces (e.g., carbon fiber composites), construction materials containing gypsum (e.g., wall board, dry wall, sheet rock, plasterboard), wood, plastic, or any combination of such surfaces. In some embodiments, at least one (or both) of the first and second surfaces is a metal surface. In other embodiments, at least one (or both) of the first and second surfaces is a polymer matrix composite surface, which may be any type of polymer that contains filler particles, such as any of those described above, embedded within. The method may also include a subsequent step of reheating the bonded (adhered) surfaces to soften the adhesive for the purpose of repairing defects in the adhesive, or for the purpose of removing the adhesive to re-use or recycle it.

Examples have been set forth below for the purpose of illustration and to describe certain specific embodiments of the invention. However, the scope of this invention is not to be in any way limited by the examples set forth herein.

### EXAMPLES

### Efficient PET Deconstruction via Aminolysis

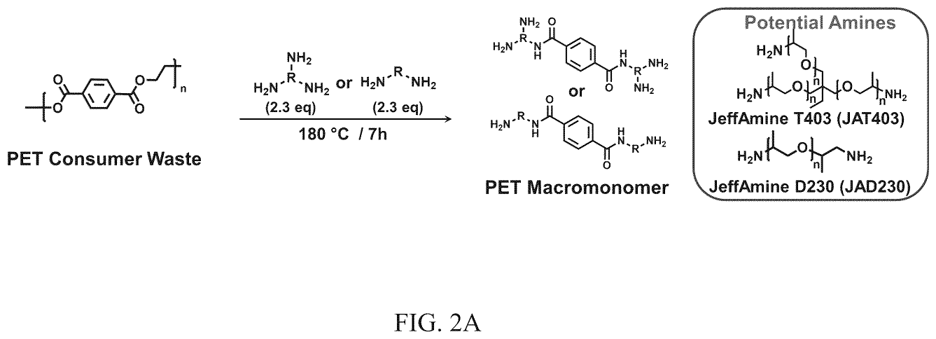

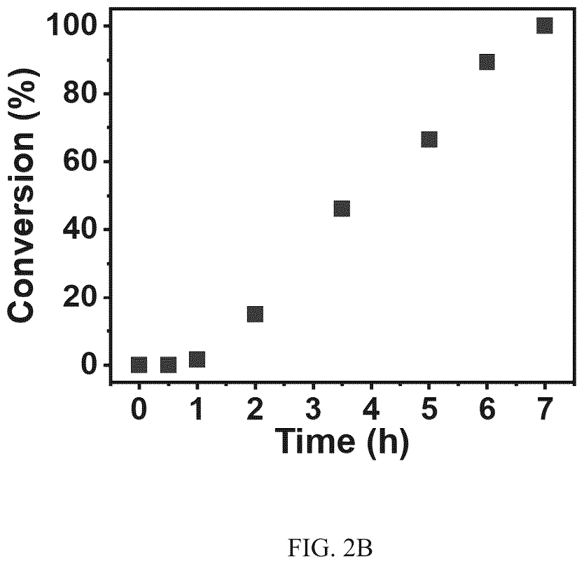

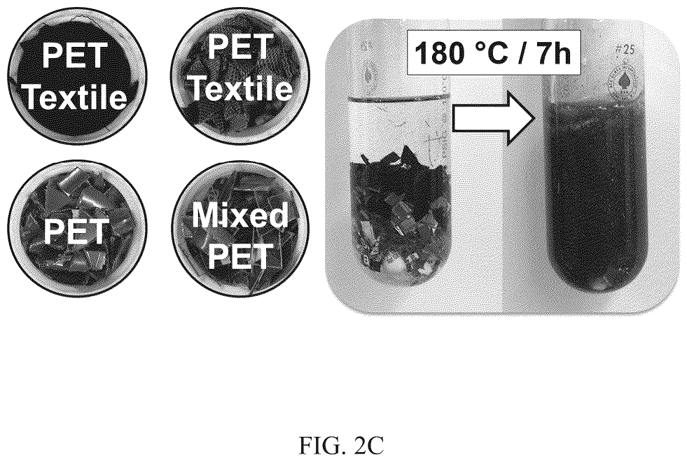

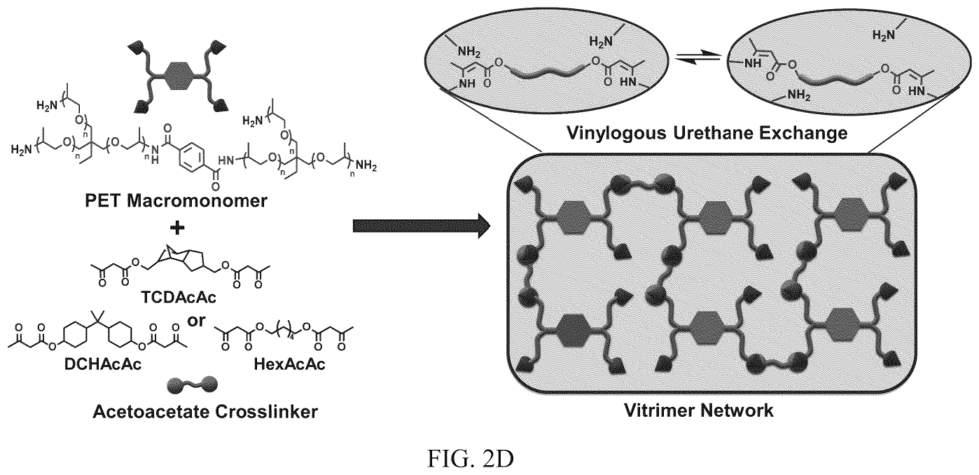

To upcycle consumer PET waste, PET was deconstructed through a facile, readily scalable, catalyst-free, solvent-free, and one-pot aminolysis reaction, where PET wastes were mixed with an excess of Jeffamine™ T403 (JAT403) (2.3 mol eq) and heated at 180° C. The JAT403 was selected for aminolysis due to its low cost and commercial availability, rendering PET deconstruction a viable and efficient process for industrial implementation. PET waste (egg carton) was completely deconstructed into macromonomer, a bulky tetramine with a terephthalamide core, within 7 h at 180° C. To monitor the progress of the reaction, aliquots were taken from the reaction at various time points and analyzed via 1H nuclear magnetic resonance (NMR) spectroscopy. Complete deconstruction of PET to the macromonomer was achieved within 7 h with a short period of inhibition during the first hour, typical of heterogenous reactions (FIG. 2B). After finishing the deconstruction, the macromonomer was isolated as a viscous, light-yellow liquid through distillation to isolate the ethylene glycol byproduct, followed by precipitation with hexanes to remove excess JAT403. Notably, both the ethylene glycol and JAT403 removed from the reaction mixture have potential for reuse. The 1H NMR spectrum and Matrix-assisted laser desorption ionization time-of-flight (MALDI-TOF) mass spectrum for the macromonomer confirmed conversion of the PET and the high purity of the product. A comparable experiment was repeated with Jeffamine™ D230, a linear diamine, to demonstrate that other nucleophilic amines could be used to deconstruct PET.

To confirm the versatility of the presently described approach and demonstrate that any PET source can be utilized for macromonomer synthesis, the feedstock was expanded beyond egg cartons to PET bottles, textiles, and mixed PET containing dyes and additives (FIG. 2C). Textiles pose a significant challenge for mechanical recycling due to the flexibility of the fibers and greater chemical complexity compared to rigid PET bottles and containers. Two distinct textile samples were investigated: a green fabric composed of 40% cotton and 60% PET, and a black fabric made entirely of PET. Each were successfully deconstructed through addition of excess amine and heating at 180° C. for 7 h. The cotton matrix from the blended fabric was recoverable, and NMR analysis confirmed that the resulting PET macromonomer from both textile sources matched that from pure PET pellets. Likewise, it was necessary to confirm whether PET macromonomer could be selectively isolated in the presence of other plastics, adhesives, dyes and plasticizers. To address this, a PET body-care container containing mica and colorant as well as a PET water bottle with a PE label and adhesive were added to the textile feedstock. All components, textiles and mixed PET waste, were combined in a pressure tube with 5 equivalents of JAT403 by mass and heated at 180° C. for 7 h (FIG. 2C). After completion, the reaction mixture was centrifuged to remove unreacted solids, and the desired product was isolated via five successive precipitations with hexanes. After drying, the product was redissolved in THF, filtered to eliminate any remaining solids, and dried in a vacuum oven overnight (110° C.). After drying, the sample was analyzed by 1H NMR and confirmed the presence of pure PET macromonomer. To validate the economic viability of our deconstruction process, a technoeconomic analysis (TEA) was conducted to determine the cost per kilogram of the deconstructed monomer. TEA results revealed a total cost of $5.37/kg at a production rate of 6 kg/day, making it affordable and cost-competitive with other upcycled materials. highlighting the potential for commercialization. Notably, the TEA identified the aminolysis reagent, JAT403, as the primary cost driver (87%), with costs projected to decrease significantly upon scale-up.

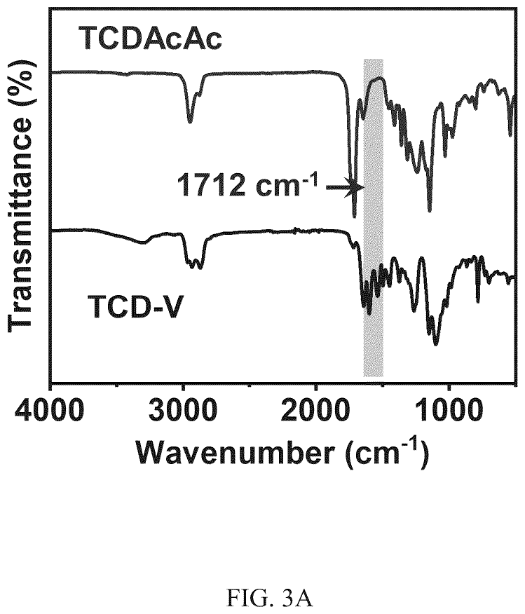

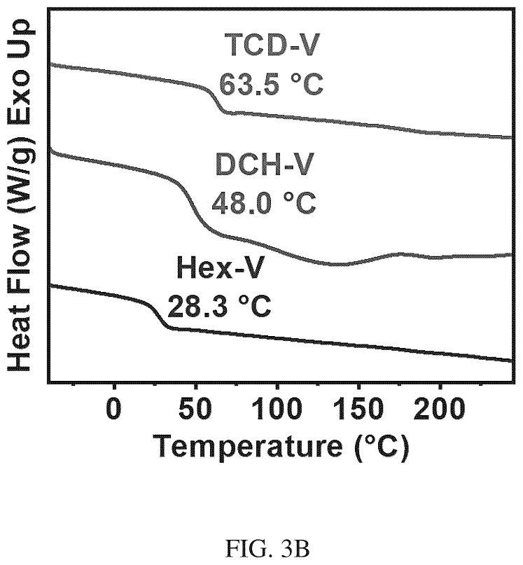

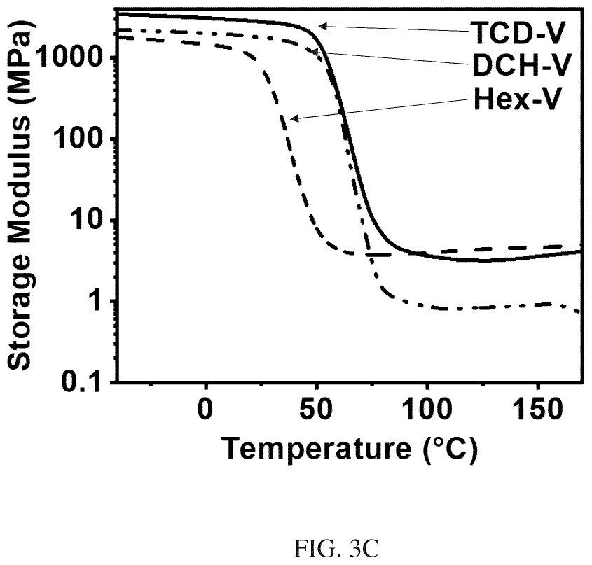

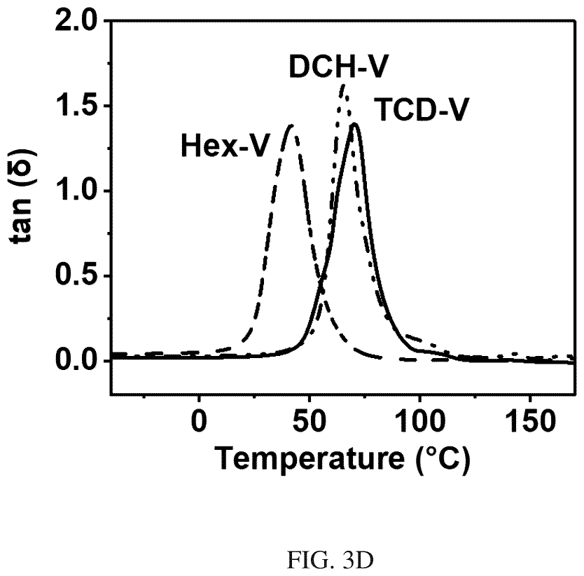

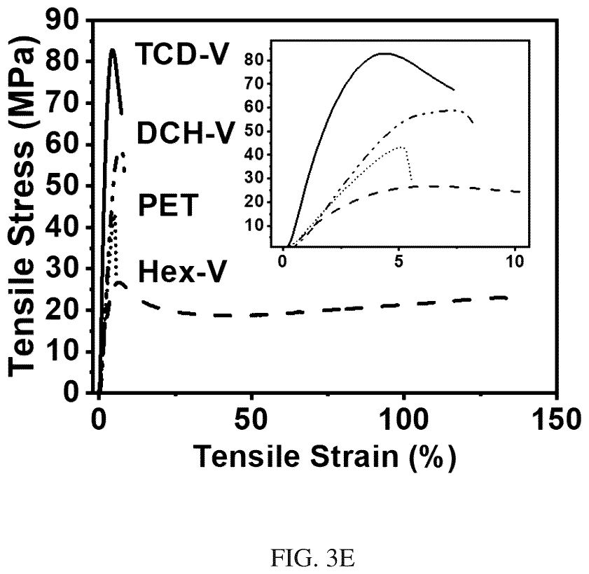

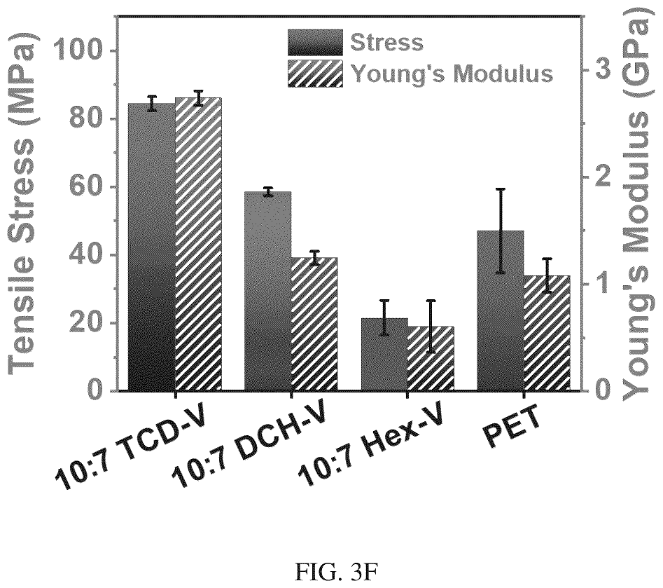

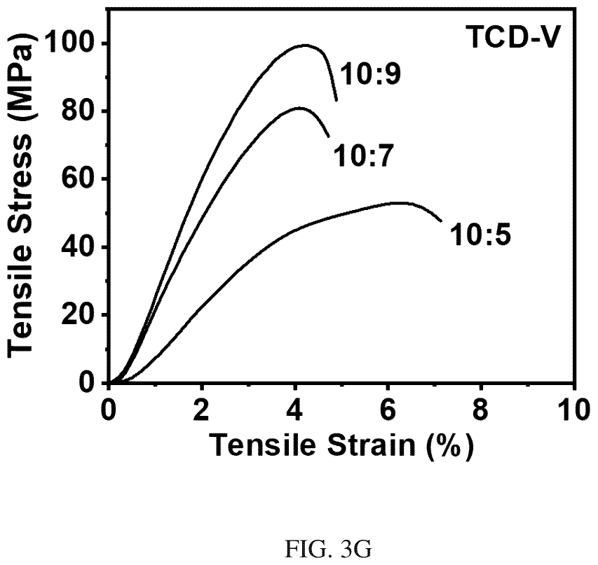

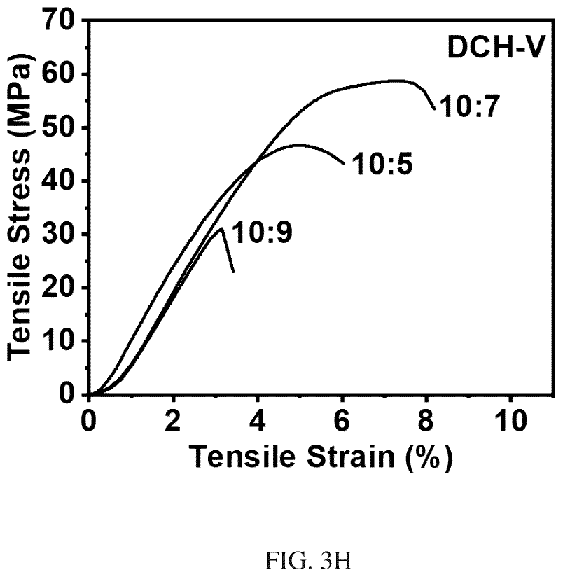

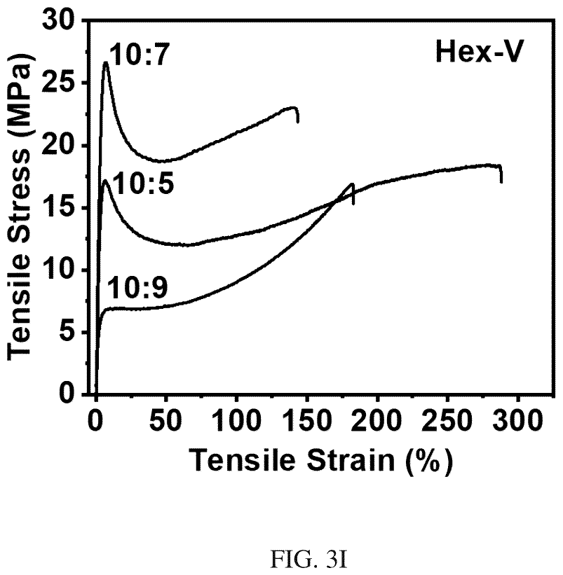

With the synthesis and characterization of the PET macromonomer complete, the next step was to explore its potential as a precursor for functional materials. The macromonomer was upcycled into vitrimer through dynamic vinylogous urethane formation with acetoacetate crosslinkers, followed by drying and curing at 80° C. for 16 h (FIG. 2D). To explore the effect of different crosslinkers on the vitrimer properties, three types of acetoacetates were tested: ring-bearing tricyclodecane-acetoacetate (TCDAcAc) and propane-2,2-diyldicyclohexane-acetoacetate (DCHAcAc) for structural strength, and hexyl-acetoacetate (HexAcAc) to enhance flexibility and toughness. The acetoacetate crosslinkers were synthesized by refluxing diol precursors with excess tert-butyl acetoacetate at 150° C. for 5 hours, followed by distillation. 1H NMR spectroscopy confirmed structure and purity of the synthesized acetoacetate crosslinkers. Vitrimers, labeled as TCD-V, DCH-V and Hex-V, were synthesized from TCDAcAc, DCHAcAc, and HexAcAc crosslinkers, respectively. Initially, TCD-V, DCH-V, and Hex-V vitrimers containing 30% free amine (amine: AcAc ratio of 10:7) were synthesized to form a crosslinked network while maintaining enough free amines to allow for dynamic bond rearrangement. The formation of vinylogous urethane cross-linking was evidenced by Fourier transform infrared (FTIR) spectroscopy (FIG. 3A). Disappearance of the C═O peak at 1712 cm-1 of the crosslinker indicated consumption of the acetoacetate group. Solvent resistance tests also confirmed successful crosslinking and stability, as the TCD-V film remained intact even after 5 days soaking under various solvents including toluene, dichloromethane, methanol, tetrahydrofuran (THF), dimethylformamide, and water, which dissolved the macromonomer and crosslinker individually. Furthermore, rigorous water stability testing at 50° C. for 15 days showed no dissolution or swelling of the vitrimer film, indicating high stability in aqueous environments, seemingly due to the high crosslinking density.

### Thermomechanical Properties of Upcycled PET Vitrimer

The thermal properties of upcycled PET vitrimers were thoroughly analyzed to determine their glass transition temperatures (Ts) and overall thermal stabilities. Thermogravimetric analysis (TGA) showed decomposition temperatures ranging from 285° C. to 305° C. for vitrimers with an amine: AcAc ratio of 10:7, in range of PET working temperatures and comparable to other vinylogous urethane vitrimers. A slight mass change was also observed at 100° C. and was attributed to evaporation of water absorbed through ambient humidity. Differential scanning calorimetry (DSC) identified a single T_{g} for all vitrimers (FIG. 3b), with cyclic DCH-V having the highest T& (68.2° C.), followed by TCD-V (63.5° C.), and Hex-V (34.2° C.). Notably, the vitrimers with ring-bearing acetoacetates (DCHAcAc and TCDAcAc) showed significantly higher Ts values than the sample prepared with the linear alkyl-crosslinker (HexAcAc). These results suggested that tailoring the crosslinker structure could induce broad material properties, ranging from high Ty to low T& materials. In addition, the amine: AcAc ratio also influences T_{g}, for example, the TCD-V with amine: AcAc ratio of 10:5 showed lower T_{g} (58.4° C.), while the ratio of 10:9 increased T& (66.0° C.). A similar trend was observed for Hex-V and DCH-V. The observed increase in Ts was due to higher crosslink density (lower free amines), which restricted chain mobility as the network became less flexible. Dynamic mechanical analysis (DMA) of these three vitrimers with a ratio of 10:7 was used to investigate viscoelastic properties with respect to temperature (FIGS. 3C and 3D). TCD-V exhibited the highest storage modulus at temperatures below 50° C. and was surpassed at higher temperatures by DCH-V. The tan 8 peaks, (FIG. 3D) represent the Ts and were in good agreement with the values from DSC. All three vitrimers showed a rubbery plateau, providing evidence of crosslinking. The crosslinking density, calculated from the rubber elasticity equation (E=3RTv), was highest for TCD-V (570 mol·m⁻³), slightly lower for Hex-V (410 mol·m⁻³), and lowest for DCH-V (260 mol·m⁻³). The higher crosslinking density of TCD-V supports its higher storage modulus despite the sample exhibiting a lower T_{g} than DCH-V. Notably, both DCH-V and TCD-V possessed Ts values within the range of what is typically reported for commercial PET (67-81° C.).

To assess the mechanical integrity and robustness of the synthesized PET vitrimers, thorough tensile testing was conducted. Focusing on a 10:7 amine: AcAc ratio, the performance of the presently described vitrimers was compared against commercially available PET, revealing significant enhancements in ultimate tensile strength, Young's modulus, and toughness. Among the synthesized vitrimers, TCD-V exhibited the highest ultimate tensile strength (UTS) at 84.4 MPa, followed by DCH-V (58.5 MPa) and Hex-V (22.8 MPa) (FIGS. 3E and 3F). A similar trend was observed for Young's modulus, with TCD-V again demonstrating the highest value (2.73 GPa), surpassing both DCH-V (1.25 GPa) and Hex-V (0.604 GPa). While exhibiting lower strength and stiffness, the linear Hex-V demonstrated the highest tensile strain (165%) and toughness (43.8 MJ·m⁻³). These findings suggest that the rigid TCD crosslinker promoted the formation of robust networks of vinylogous urethane linkages, leading to enhanced strength and stiffness. Conversely, the flexible alkyl crosslinker yielded a softer, more ductile material. The 10:7 TCD-V outperformed commercial PET, boasting an 80% increase in maximum tensile strength and a 150% improvement in Young's modulus. This superior performance underscored the tunability of TCD-V's mechanical properties through adjustments to the amine: AcAc ratio. For instance, increasing the ratio from 10:5 to 10:9 resulted in enhanced vitrimer tensile strength and Young's modulus, attributed to the incorporation of higher crosslinking densities (FIG. 3G). The highest UTS was achieved with the 10:9 TCD-V, reaching 102 MPa (FIG. 3G), which represents a remarkable 97% increase in UTS compared to commercial PET. Conversely, increasing the amine: AcAc ratio for the DCH-V and Hex-V materials resulted in increased brittleness and overall reduced material tensile strength (FIGS. 3H and 3I).

### Thermal and Chemical Recycling of Vitrimers

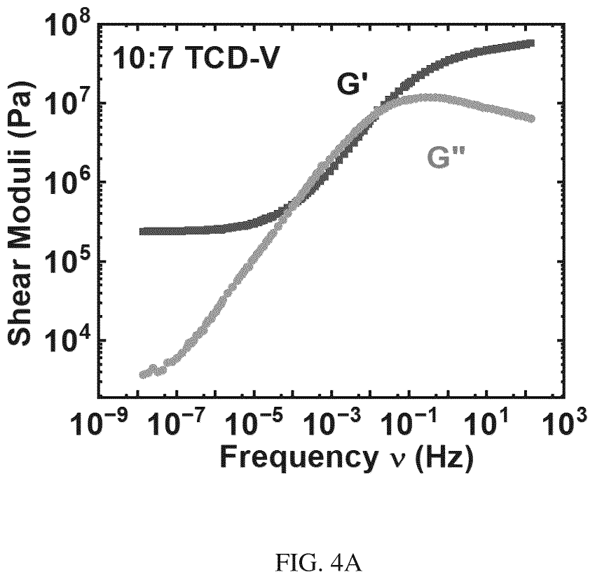

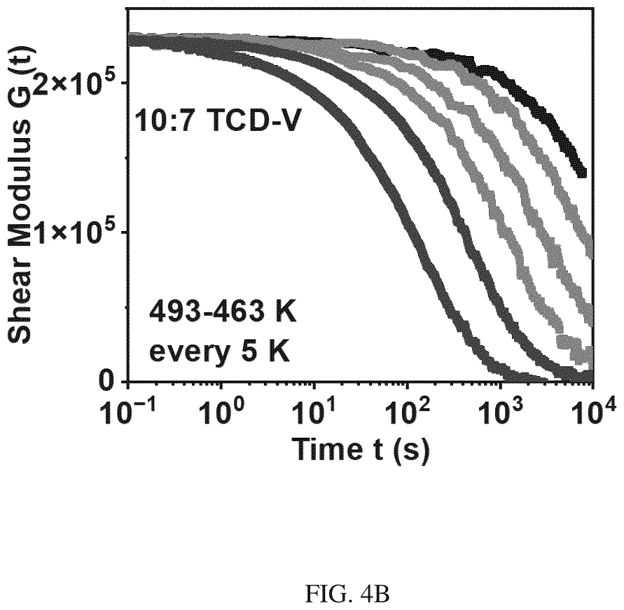

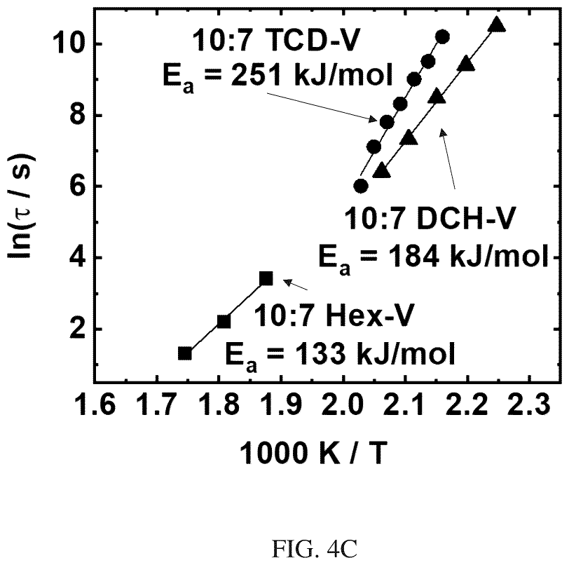

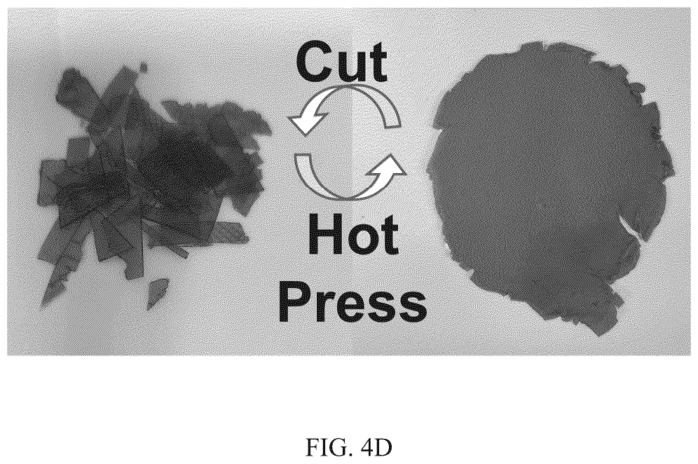

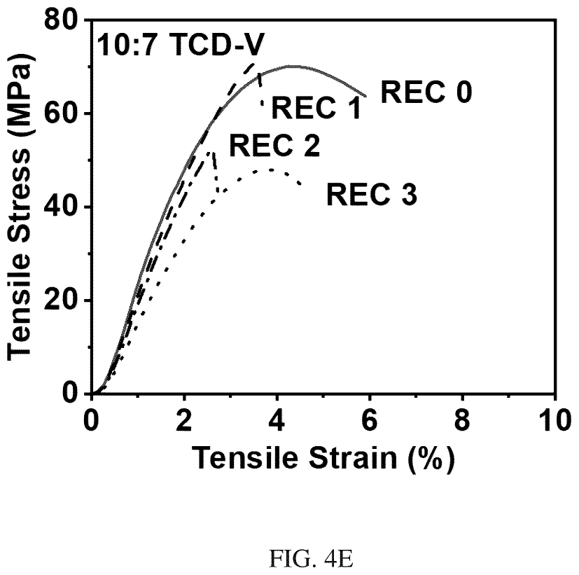

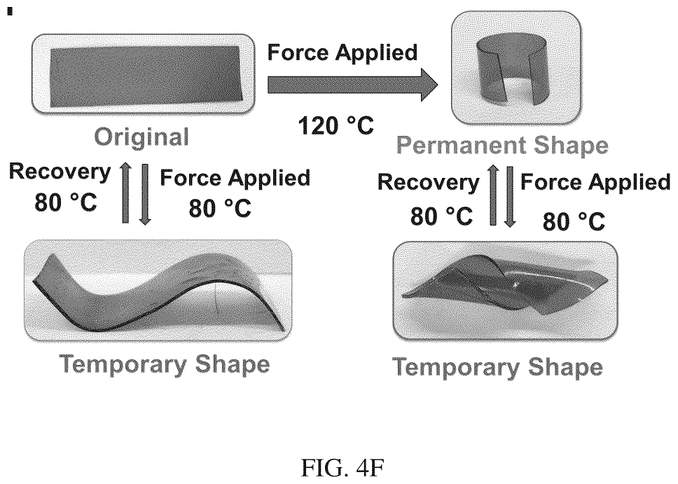

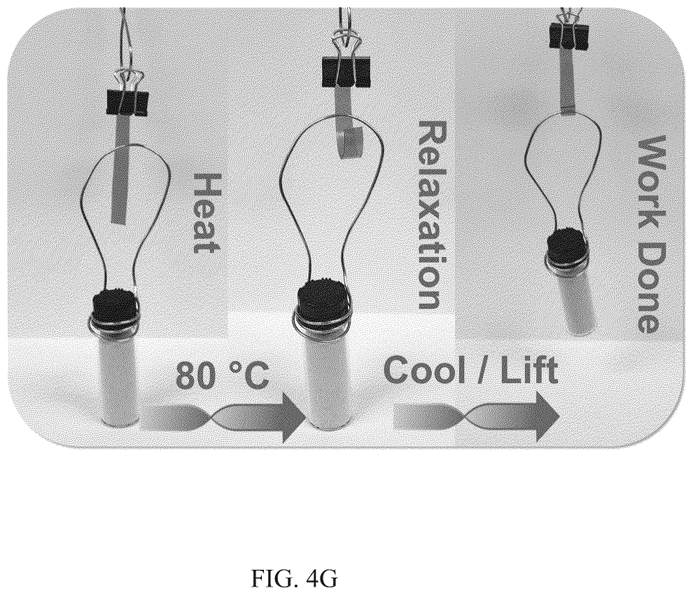

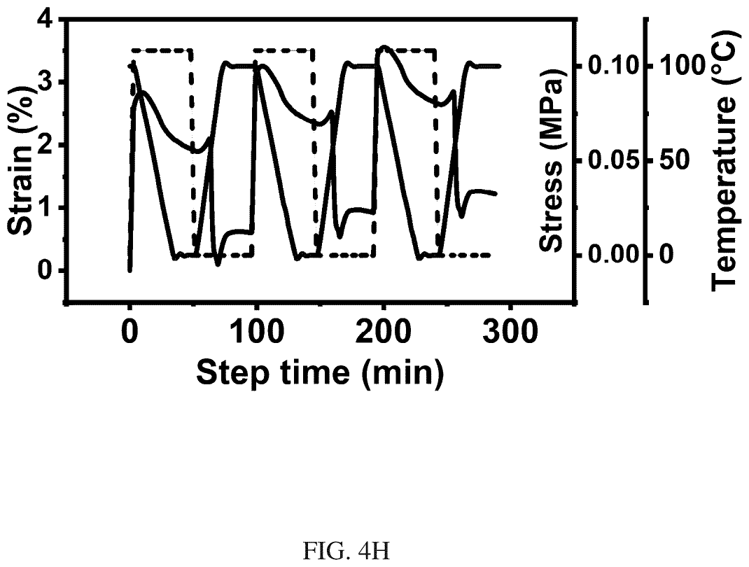

To explore the dynamic properties of all 10:7 vitrimers, a deeper analysis was conducted using oscillatory shear rheology, a method used for quantifying relaxation times within crosslinked networks. FIG. 4A presents the viscoelastic response of the 10:7 TCD-V, displaying master curves constructed by superimposing frequency sweeps conducted at various temperatures. At high frequencies, the viscoelastic response was governed by segmental dynamics, with the storage modulus (G′) approaching the GPa range and the loss modulus (G″) displaying a prominent absorption peak. In the intermediate frequency regime, a rubbery plateau emerged, characterized by a G′ value of approximately ˜1 MPa, consistent with typical dynamically bonded polymer networks. As the frequency decreases, the onset of terminal flow behavior became apparent, marked by a decline in both G′ and G″. Within this regime, G″ potentially exhibited a secondary absorption peak. However, probing the flow behavior necessitated high temperatures, where initial indications of material degradation was observed. To further probe the terminal relaxation behavior of the 10:7 TCD-V, Hex-V, and DCH-V materials, time-domain stress relaxation experiments were conducted at elevated temperatures (FIG. 4B) (493-463 K for TCD-V, 485-445 K for DCH-V, and 573-533 K for Hex-V). These stress relaxation tests were performed using a constant strain of 2% to access shear modulus decays in a dynamic range covering 10⁻²-104 s. The complete decay observed at the highest temperature confirmed that the monitored relaxation corresponded to terminal flow. The presence of distinct plateaus at short times for all temperatures minimized the impact of vertical normalization on the estimation of characteristic relaxation times (t). The parameter t was determined using stretched exponential fits. The corresponding results for all tested vitrimers are included in FIG. 4C. The temperature dependences of the t obtained from Kohlrausch fits have been interpolated using Arrhenius laws tμexp (E./RT), with R as the gas constant, which yielded the activation energies Eₐ of 251 KJ/mol for 10:7 TCD-V, 184 KJ/mol for 10:7 DCH-V, and 133 KJ/mol for 10:7 Hex-V (FIG. 31). These values, higher than those typically reported for vinylogous urethane-based vitrimer networks, likely stemmed from the increased rigidity of crosslinker, the PET macromonomer and the high degree of crosslinking. Importantly, the present findings highlight the significant impact of segmental dynamics and crosslink density on terminal flow behavior. Interestingly, the 10:7 Hex-V needed very high temperatures to reach terminal flow despite being the softer of the two tested materials. It is possible that this could be due to strong noncovalent interactions within the Hex-V network, potentially due to hydrophobic effects where the nonpolar hexyl linkers attempt to isolate from the polar, propylene glycol moieties on the macromonomer structure.

Building upon the observed terminal flow behavior at elevated temperatures, the thermal reprocessing potential for both 10:7 TCD-V and Hex-V was investigated. Reprocessing was conducted by cutting each sample into small pieces and hot-pressing at 200° C. and 500 psi for 30 min, as shown in FIG. 4D. Elevation above the Ts of the vitrimers allows for movement of the polymer chains and reconstitution of the network through transamination. The robustness of the reprocessed films was measured with tensile testing (FIG. 4E) where mechanical strength was retained after the first cycle for both the Hex-V and TCD-V with decreases observed over the following two cycles. The decrease in mechanical strength was likely due to material degradation which induces amine oxidation at the high temperatures needed for reprocessing as well as accumulation of impurities, such as dust or air bubbles, introduced during the cutting and hot-pressing steps.

The ability to thermally reprocess, and reconstitute, the TCD-V network also allows for interesting shape memory behaviors. Most thermoset materials exhibit some shape memory, where elevation above the T& allows for hot-molding of the material, where the new shape is retained upon cooling. Further elevation of the thermoset above the T_{g} will return the material to its lowest energy, originally formed shape. This behavior is true of the 10:7 TCD-V where the original, flat state was manipulated at elevated temperature (80° C.) to form a wave shape, as shown in FIG. 4F. Upon cooling, the wave became a fixed shape, though further heating returned the material back to the original state—a flat sheet. However, because TCD-V possesses dynamic covalent bonds, extended exposure to elevated temperatures can allow the initial state to be programmed. When under applied force, and elevated above the T_{g}, the TCD-V network rearranged to minimize the stress in the network, conforming to the molded shape, as shown in FIG. 4F. TCD-V was reprogrammed into a “curl” via wrapping the film around a 1-dram vial and heating at 80° C. for 16 h. The extended period of heating allowed for ideal rearrangement of the vinylogous urethane bonds, trapping the material in the desired form. Shape memory behaviors were further observed in the new, reprogrammed shape where the “curl” was temporarily fixed into a helix before returning to the “curl”. Shape memory behaviors, like those described here, can be utilized for stimuli-responsive applications like those investigated for soft-robotics.

FIG. 4G shows the reprogrammed “curl” shape being used as a hook capable of doing work by lifting a vial of sand. First, the film was flattened by heating for 30 s at 80° C. and applying a flat weight. Upon cooling, the flattened film was hung from a clip within range of the ring attached to the vial of sand. After heating again for 30 s at 80° C., the film returned to its programmed state (curl), looping through the ring attached to the sand. Upon cooling, the hardened film was lifted, carrying the vial of sand. Shape memory behaviors were further characterized through a cyclic DMA experiment to monitor changes in strain correlated to thermal shape-fixing, as shown in FIG. 4H. The shape memory temperature was determined based on the results of DSC and was selected at 10° C. above the T_{g}. The sample was initially deformed under constant stress at a temperature of 100° C. During this shape-fixing stage, a strain recovery of 1% was observed due to the viscoelastic nature of the material. The DMA held this force constant while cooling the sample to 10° C. to obtain a temporary shape. When the force was released to zero at 10° C., a slight strain recovery of less than 0.5% was observed. The slight aberrances in recovery behaviors are due to the extreme stiffness and strength of the 10:7 TCD-V material.

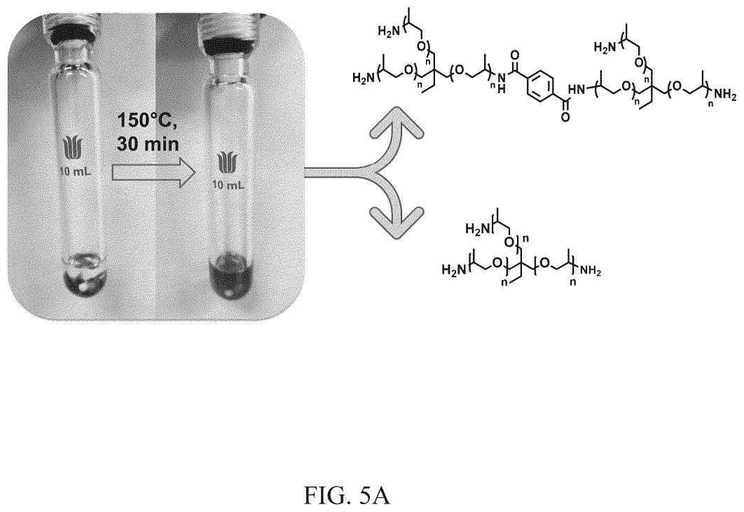

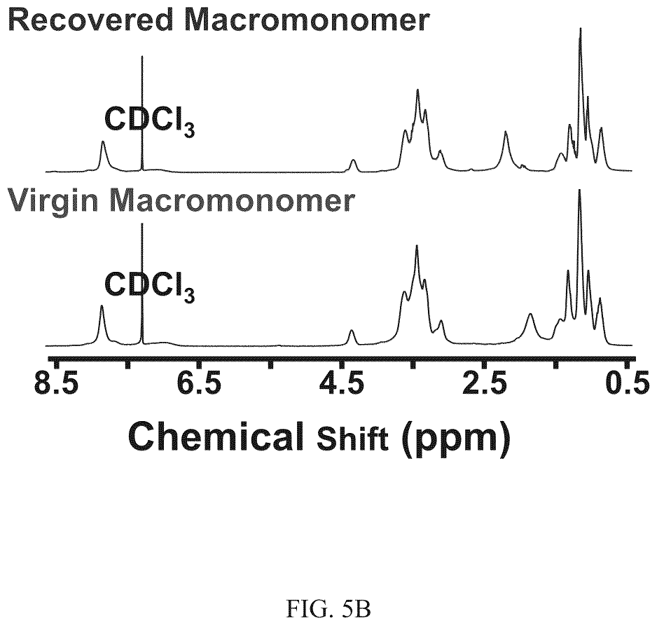

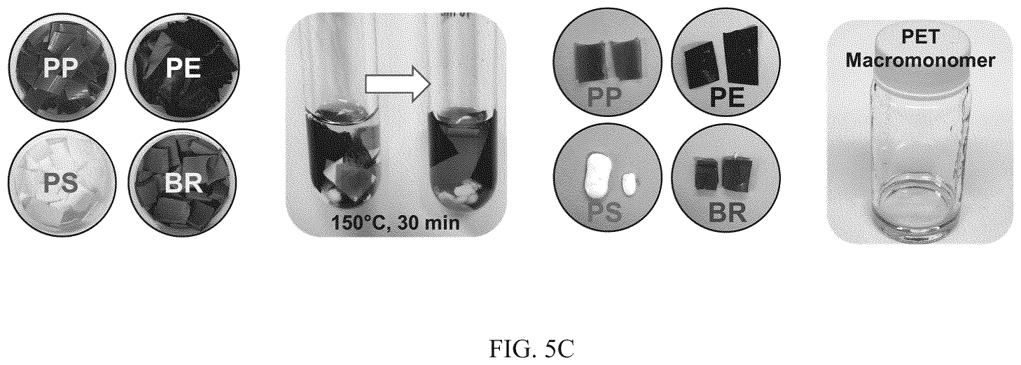

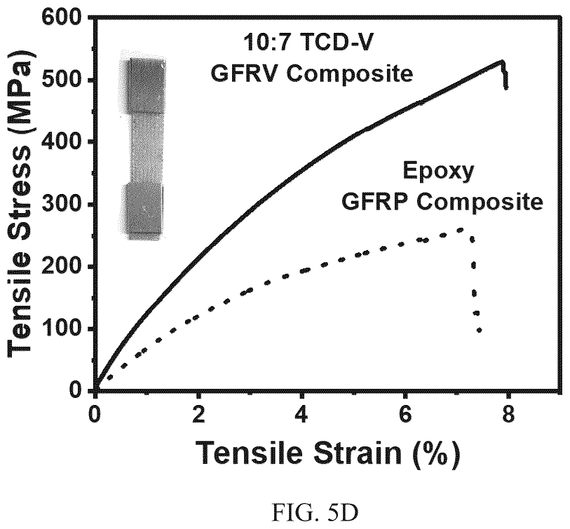

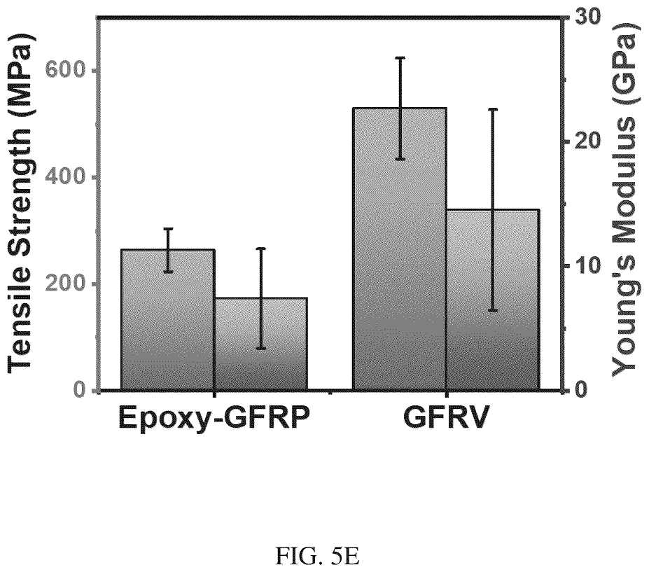

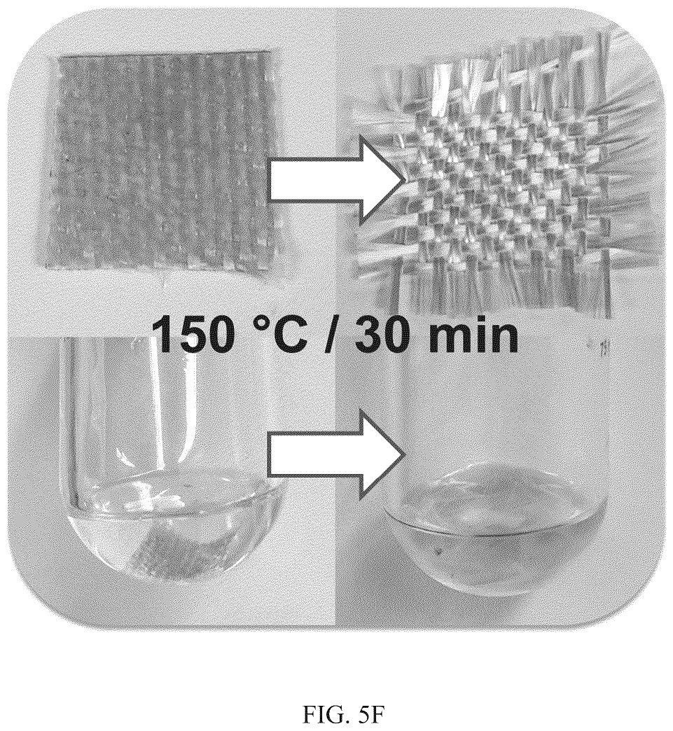

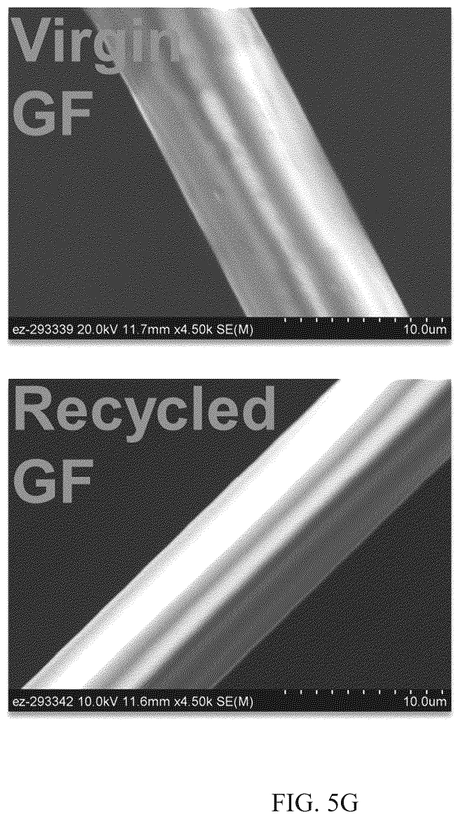

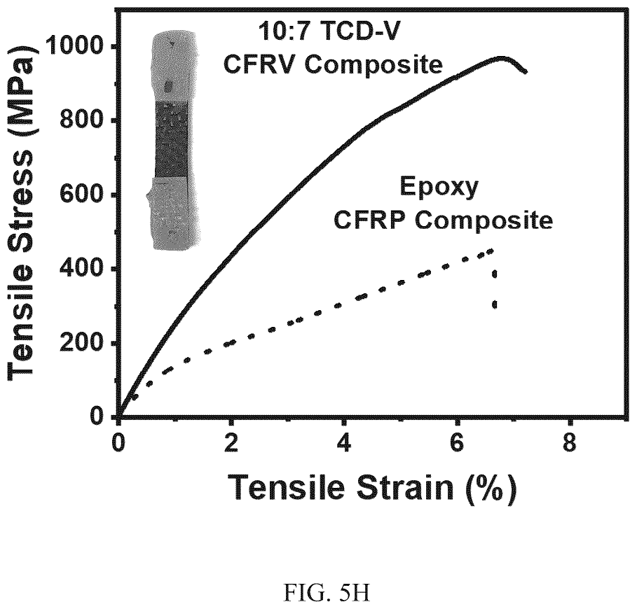

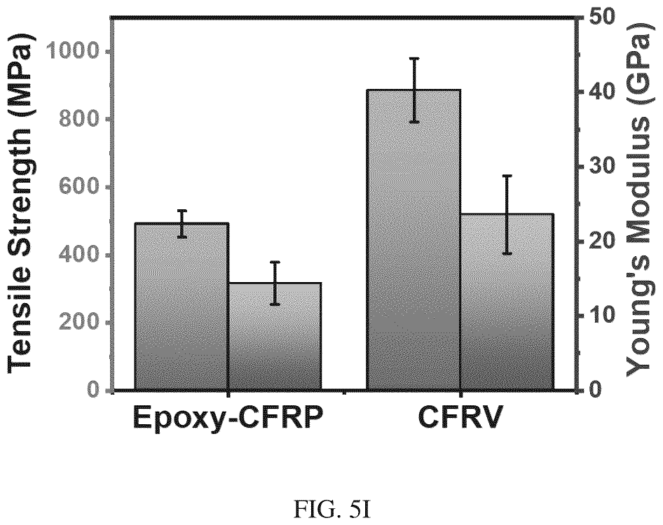

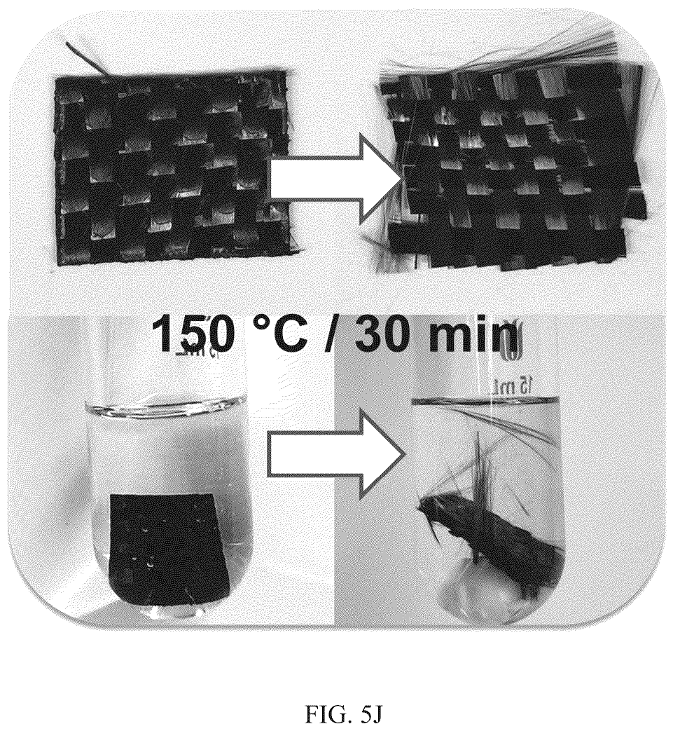

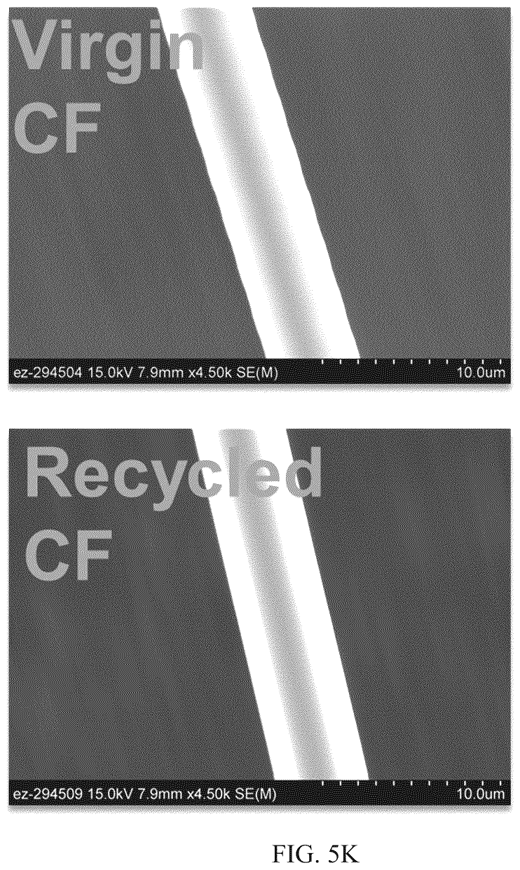

While most commercial plastics would become unusable after showing signs of material degradation, vitrimer plastics are easily chemically recycled and reconstituted, achieving complete plastic circularity. To demonstrate the easy deconstruction, the 10:7 TCD-V was mixed with excess dodecylamine as the solvent, as shown in FIG. 5A. Use of a large, alkyl amine allows for simple separation of the crosslinker and macromonomer after reacting. Heating the mixture at 150° C. resulted in rapid depolymerization, yielding the PET macromonomer within 30 min. Lower temperatures (e.g., 100° C.) also proved effective, albeit with longer reaction times. The PET macromonomer was readily isolated by precipitation with hexanes in good purity, as shown in FIG. 5B. The recovered PET macromonomer was used to synthesize a new, 10:7 vitrimer film which was characterized via FTIR and tensile testing. The FTIR spectra showed identical peaks between the recycled and virgin 10:7 TCD-V films while tensile testing showed a decrease in ultimate tensile stress between the virgin and chemically recycled material. This is likely due to oxidation of the amines which occur during curing, thermal reprocessing, and chemical recycling and could be mitigated through introduction of an antioxidant to the film formulation.

A simple and efficient chemical recycling strategy for TCD-V was successfully applied to practical mixed plastic recycling. The same vitrimer deconstruction experiment was repeated in the presence of mixed commercial plastics (e.g., polypropylene (PP), polyethylene (PE), polystyrene (PS), and butadiene rubber (BR)) containing both dyes and additives (as shown in FIG. 5C). The mixed plastics and TCD-V films were heated at 150 “° C. in the presence of excess dodecyl amine. TCD-V films depolymerized into macromonomers within 30 minutes, while the mixed commercial plastics remained unchanged. The PET macromonomer was recovered through precipitation with hexanes and subsequently reused to synthesize new vitrimer plastic, demonstrating the feasibility of a closed-loop recycling process. This result holds significant implications for real-world plastic recycling systems, where sorting plastic types poses a considerable challenge.

A significant challenge for plastic recyclers is the prevalence of composite materials, especially those with permanently crosslinked resins which are incompatible with traditional recycling methods. These composites, often reinforced with glass, carbon, or natural fibers, are widely used in the automotive, wind energy, and aerospace industries due to their desirable properties such as durability, light weight, and damage resistance. However, the increased use of composites has resulted in a corresponding surge in waste, for which effective and sustainable end-of-life solutions are lacking. The absence of viable recycling options typically leads to landfilling, posing a significant environmental concern. To address this challenge, the potential of the presently described TCD-V vitrimer system was investigated for its ability to provide closed-loop recycling of composite materials. As a proof-of-concept, a glass fiber reinforced vitrimer (GFRV) composite was fabricated using a 10:7 TCD-V mixture. Three layers of woven GF were impregnated with 10:7 TCD-V, by spreading the mixture evenly between the layers of glass fiber fabric. The sample was cured at 80° C. in a vacuum oven for 16 h to yield a GFRV composite with ˜27% loading of the vitrimer resin by mass (confirmed by TGA).

The mechanical properties of GFRV composite were investigated and compared with the composites made from conventional epoxy (FIG. 5D). The resulting GFRV composite exhibited a promising tensile stress of 462 MPa and a Young's modulus of 14.5 GPa (FIG. 5E) comparable to values reported for GF composites in the literature and exceeding values for an epoxy GFRP control by 100% and 96% respectively. To evaluate recyclability, the TCD-V GFRV composite was subjected to aminolysis with excess dodecylamine at 100° C. for 3 h (FIG. 5G). This lower temperature was chosen to minimize potential damage to the fibers. After the deconstruction reaction, the GFs were retrieved and washed with methanol to remove residual dodecylamine and dissolved PET macromonomer. Scanning electron microscopy (SEM) and energy-dispersive X-ray spectroscopy (EDXS) were used to characterize the GF material before incorporation into the TCD-V composite and after subsequent chemical recycling to determine whether the GFs could maintain integrity during the chemical recycling. SEM and EDXS analysis revealed no resin attached to the fibers, and no damage to the fibers and no significant changes in carbon, nitrogen, or oxygen content on their surfaces (FIG. 5G) after the chemical recycling process, which demonstrates successful chemical recycling.

To further investigate the versatility of the TCD-V system, the same experimental procedure was applied to woven carbon fiber (CF), creating a TCD-based CFRV composite (FIGS. 5F-5I) with ˜27% loading of the 10:7 TCD-V resin by mass (confirmed by TGA). Specifically, the CFRV exhibited a remarkably high tensile stress of 886 MPa and a Young's modulus of 23.6 GPa (FIGS. 5H and 5I). These values represent a substantial improvement over the epoxy control composite, exceeding its tensile stress and Young's modulus by 80% and 63%, respectively (FIG. 5G). The chemical recyclability of the CFRV composite was also evaluated using the aminolysis process (FIG. 5J). Similar to the GFRV results, both the carbon fiber fabric and the PET macromonomer were successfully recovered. SEM and EDXS data confirmed the structural integrity of the carbon fibers after the chemical recycling reaction, with no evidence of residual vitrimer material (FIG. 5K). These results demonstrate the efficacy of the TCD-V system in enabling closed-loop recyclability not only for solid plastic materials but also for high-performance composites, including both glass fiber and carbon fiber reinforced systems. This capability has significant implications for promoting sustainable material lifecycles and reducing the environmental impact of composite materials.

This work demonstrated a versatile strategy to upcycling PET waste into a high-performance vitrimer material endowed with multicycle reusability and closed-loop recyclability. The catalyst- and solvent-free aminolysis method described above permits the facile deconstruction of diverse PET waste streams, including colored PET and mixed textiles, into reactive tetramine macromonomers. A technoeconomic analysis indicated that the presently described PET deconstruction process is economically viable, with a production cost of $5.37/kg at a scale of 6 kg/day. The resulting PET tetramine macromonomers were upcycled into a robust vitrimer through the formation of dynamic vinylogous urethane bonds. The vitrimer exhibited high mechanical properties, achieving a maximum tensile strength of 102 MPa (10:9 TCD-V), significantly surpassing that of virgin PET. The dynamic interactions in the vitrimer network also provided thermal reprocessability and reconfigurable shape memory behavior. Significantly, the presently described upcycled PET vitrimer demonstrated closed-loop chemical recyclability, providing the quantitative recovery of the macromonomer under mild conditions, even from mixed plastic feedstocks. Furthermore, the presently described TCD-V vitrimer system was investigated for closed-loop recycling of GF and CF reinforced composites. Both GFRV and CFRV composites demonstrated promising mechanical properties with remarkable tensile strengths of 462 MPa and 886 MPa respectively, exceeding those of conventional epoxy controls. The streamlined chemical recycling strategy described herein, based on aminolysis, successfully recovered both fiber materials and monomers, demonstrating the potential of the TCD-V system for sustainable composite recycling. Overall, this work demonstrates a breakthrough in upcycling plastic waste into circular plastics with embedded versatility, uncovering a path for transforming common plastic waste into valuable resources. The presently described approach offers a practical, economically feasible, and sustainable solution to the escalating global challenge of plastic waste accumulation in both landfills and the environment.

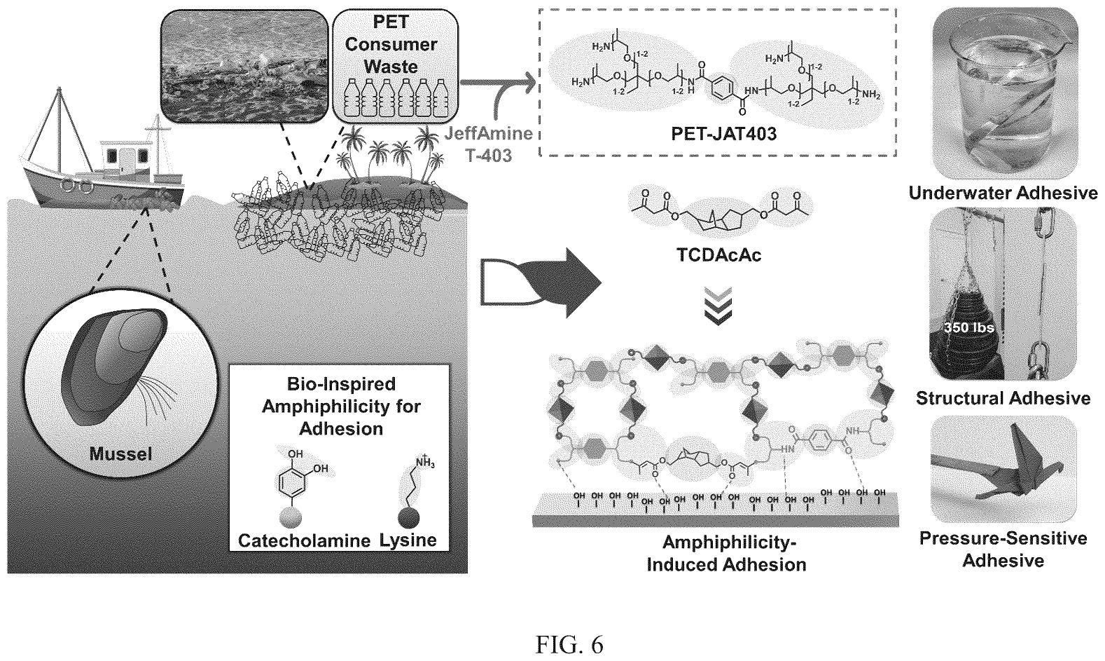

The present work has demonstrated the development of a versatile, tough, reversible adhesive synthesized from consumer PET waste, combining bio-inspired amphiphilicity and dynamic interactions (FIG. 6). An amphiphilic tetraamine, synthesized via catalyst- and solvent-free aminolysis of PET using Jeffamine T-403 (JAT403), was designed to react with a facially amphiphilic (one side hydrophobic and the other hydrophilic) di-acetoacetate crosslinker, generating a dynamic vinylogous urethane-bonded adhesive. The resulting adhesive exhibited strong adhesion to various substrates in diverse conditions, including underwater and dry environments, due to the incorporation of both hydrophobic and hydrophilic moieties. Moreover, the inclusion of dynamic covalent bonds enabled reversibility, repairability, and recyclability. Analysis of crosslinker stoichiometry revealed that higher crosslinking densities enhanced adhesion in both underwater and dry conditions on common structural substrates, while lower crosslinking densities exhibited pressure-sensitive adhesion. The developed adhesive was room-temperature curable, solvent-free, and applicable in both liquid and dry states, offering high strength and toughness. While this study focused on PET waste and vinylogous urethane bonds, the concept is extendable to other condensation polymers and dynamic amine-based bonds. This approach provides a sustainable route for upcycling plastic waste into a high-performance circular adhesive.

### Design of Versatile and Reversible Adhesive

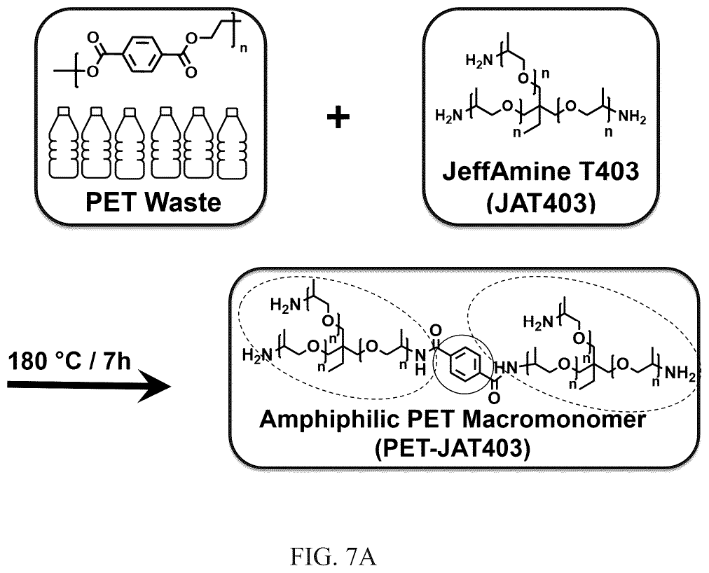

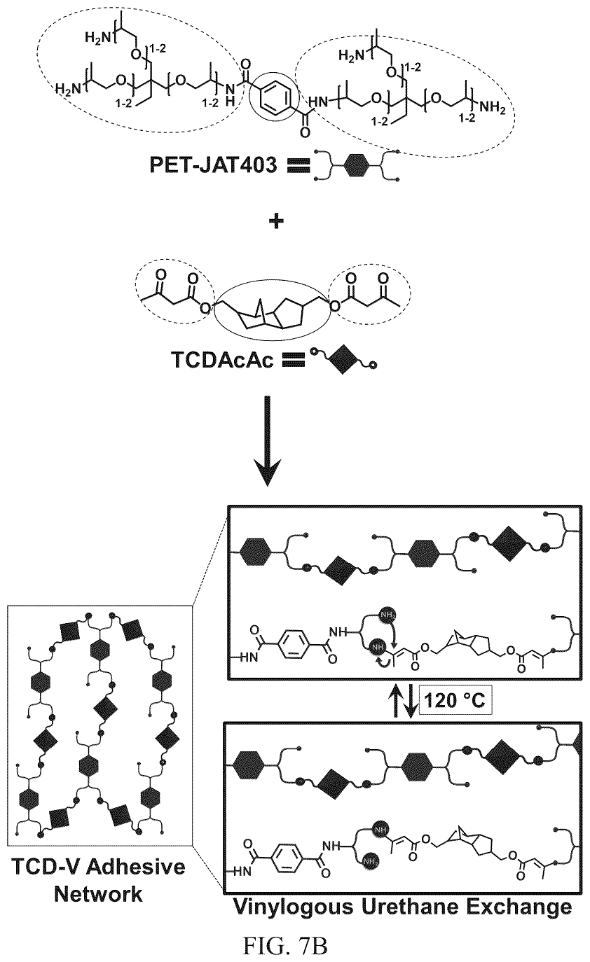

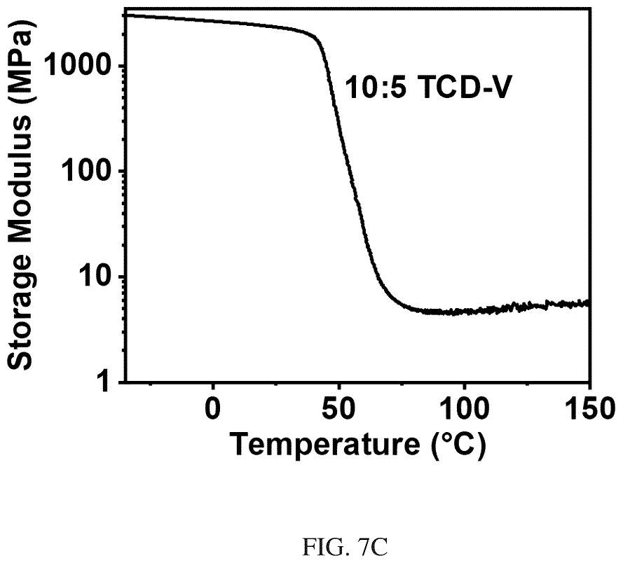

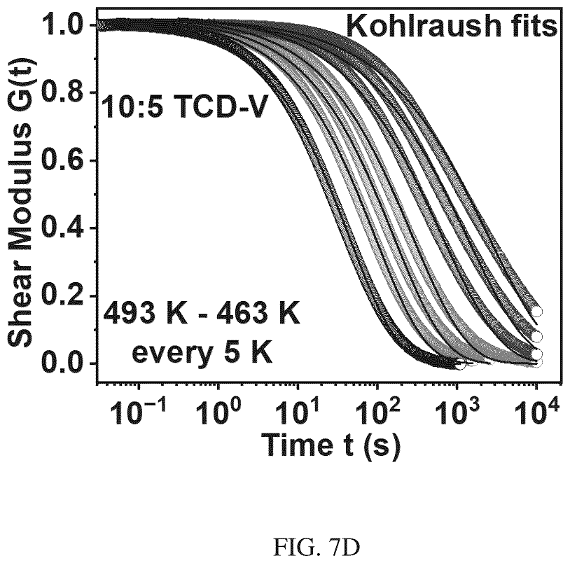

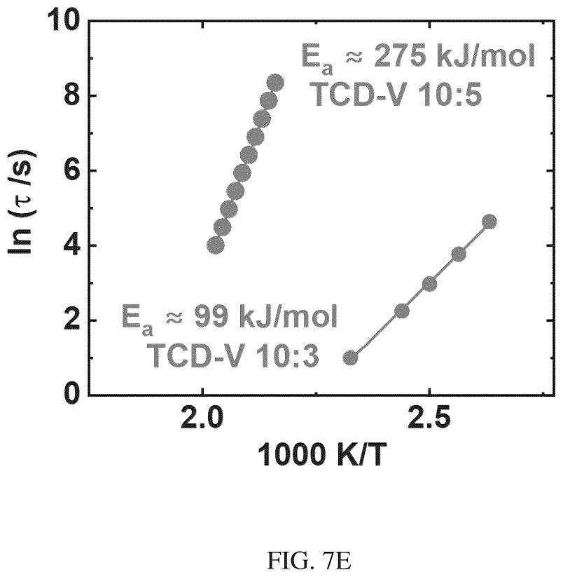

To design a sustainable, reversible, and versatile adhesive from PET consumer waste, the present study began by deconstructing PET to form an amphiphilic tetraamine macromonomer. The deconstruction process involved a one-pot, catalyst- and solvent-free aminolysis reaction of solid PET waste with JAT403 a commercially available triamine containing both hydrophilic propylene glycol groups and primary amines (FIG. 7A). The resulting tetraamine macromonomer (PET-JAT403) was isolated via distillation and precipitation in qualitative yield and high purity. The PET-JAT403 chemical structure features a rigid hydrophobic core and hydrophilic arms, resembling naturally occurring amphiphilic catecholamine adhesives. To maximize amphiphilicity, a facially amphiphilic crosslinker was designed, consisting of a hydrophobic tricyclodecane (TCD) core functionalized with hydrophilic tert-butyl acetoacetate (AcAc), referred to here as TCDAcAc. As a control, a second crosslinker derived from ethylene glycol was synthesized to better understand the influences of facial amphiphilicity. Facial amphiphilicity enhanced underwater adhesion, where hydrophilic moieties encouraged bonding while hydrophobic components prevented water infiltration at the adhesive joint. The liquid state of both the macromonomer and crosslinker at room temperature provided advantages of surface wettability during application, promoting adhesive strength and eliminating the need for solvents. The adhesive, termed TCD-V, is formed by vigorously mixing the liquid amphiphilic PET macromonomer and TCDAcAc crosslinker at room temperature for 30 seconds, creating dynamic covalent vinylogous urethane bonds (FIG. 7B). The ratio of amine to acetoacetate functionality will be referenced as the amine: AcAc ratio and is important for ensuring an excess of amines to enable reversibility/reprocessability of the adhesive. Vinylogous urethane exchange occurs via transamination reactions, where free amines within the crosslinked network react with vinylogous urethane bonds when heated above the glass transition temperature (T_{g}) to reconfigure the polymer network (FIG. 7B). The formation of vinylogous urethane crosslinks was confirmed using FTIR spectroscopy, through observation of a reduction in the acetoacetate C═O peak intensity at 1732 cm 1, indicative of crosslinker consumption. TCD-V showed high storage modulus (G′) below T_{g} and decreased as the T_{g} was surpassed. The appearance of a slight increase near the end of the rubbery plateau in the DMA curve (FIG. 7C) further supports the presence of associative-type dynamic crosslinking in TCD-V. This behavior is typical of associative-type dynamic bonds where formation and breakage of the bonds occur simultaneously. This dynamic rearrangement allows for stress-relaxation behaviors, shown in FIG. 7D, like those seen in thermoplastics, despite being covalently crosslinked.

The characteristic relaxation times (t) were determined using both stretched exponential fits (Kohlrausch fits) and a simplified “1/e” approach. The corresponding t obtained from Kohlrausch fits interpolated using Arrhenius law yielded the activation energies of the vinylogous urethane exchange in the 10:5 TCD-V with values of 275 KJ/mol (FIG. 7E). This Arrhenius behavior confirms the reversibility of the vinylogous urethane exchange and indicates that the relaxation process is thermally activated. The crosslinking was further validated by its resistance to various solvents, including water, tetrahydrofuran (THF), acetone, and toluene, after 16 h of submersion. In this solvent resistance study, no notable dissolution was observed, even after 72 h of submersion in water. Subsequent characterization of the swelling ratio and soluble fraction of the crosslinked network in water for 72 h revealed a 0% swelling ratio and a minimal soluble fraction (2.9%) for the 10:7 TCD-V adhesive, confirming the underwater stability of the TCD-V adhesive. A possible explanation is that the balanced amphiphilicity in the TCD-V can permit strong adhesion to diverse substrates in both wet/underwater and dry conditions through noncovalent interactions like van der Waals and H-bonding.

### Underwater Adhesive Performance

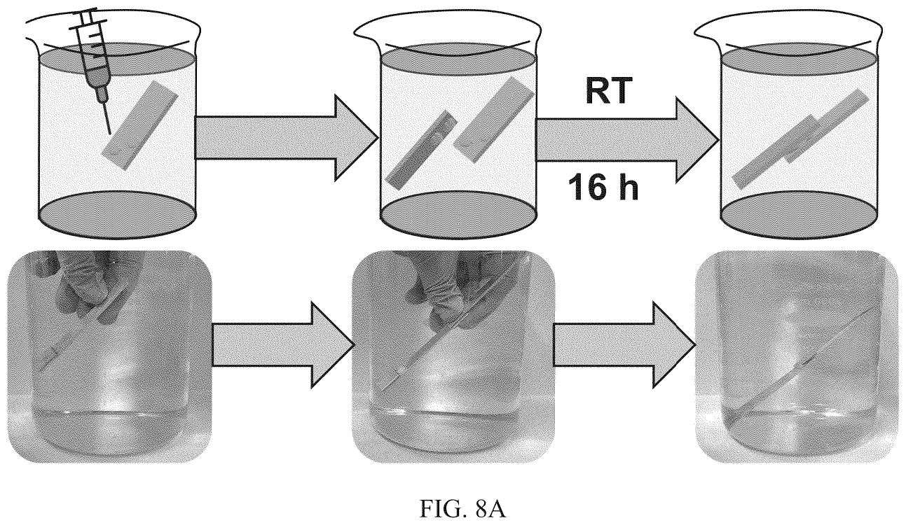

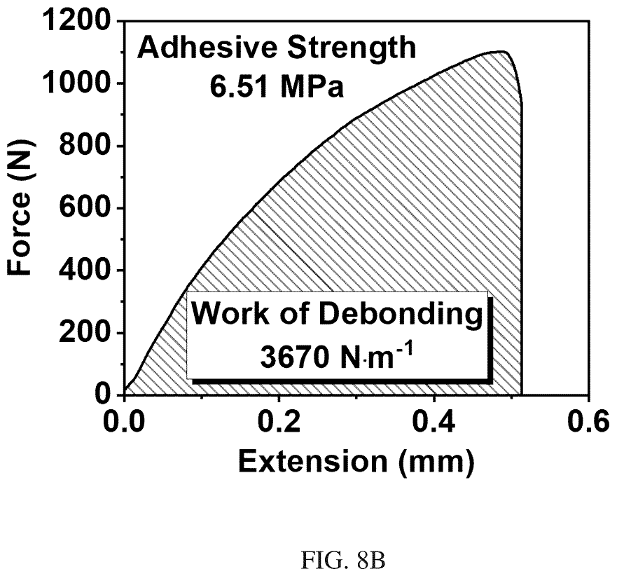

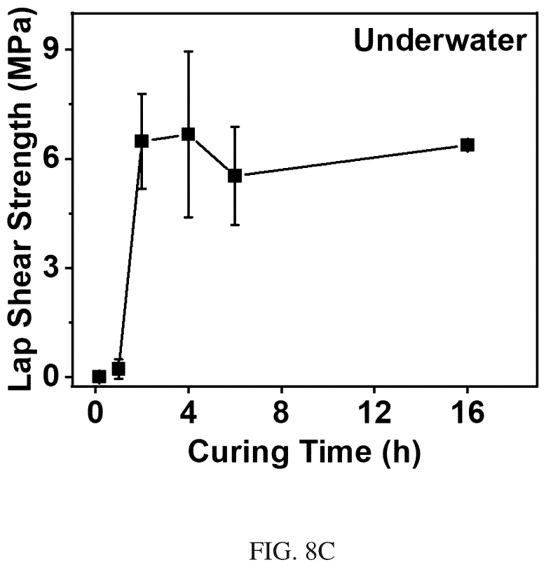

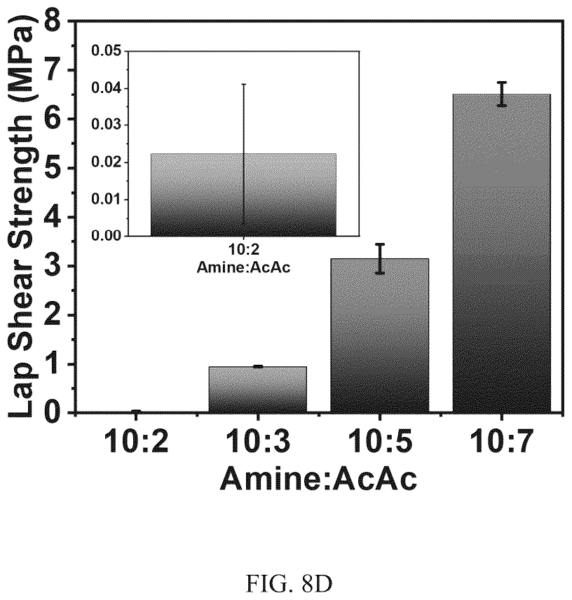

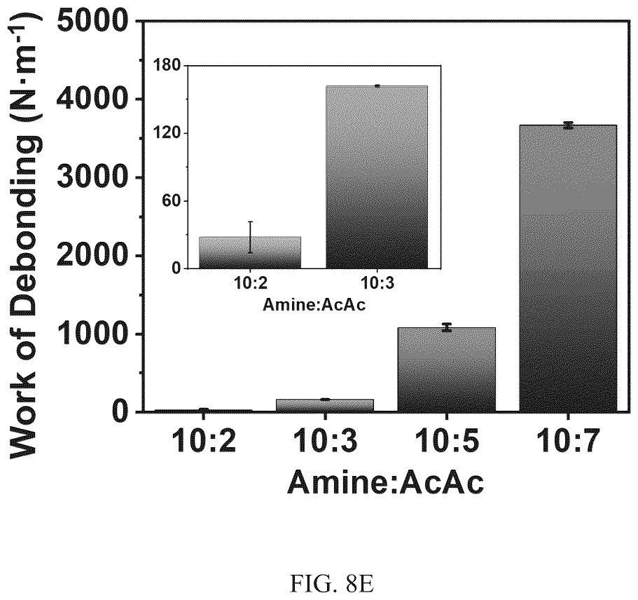

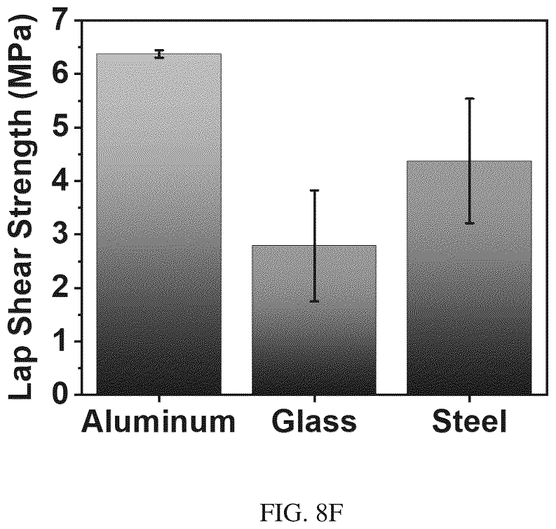

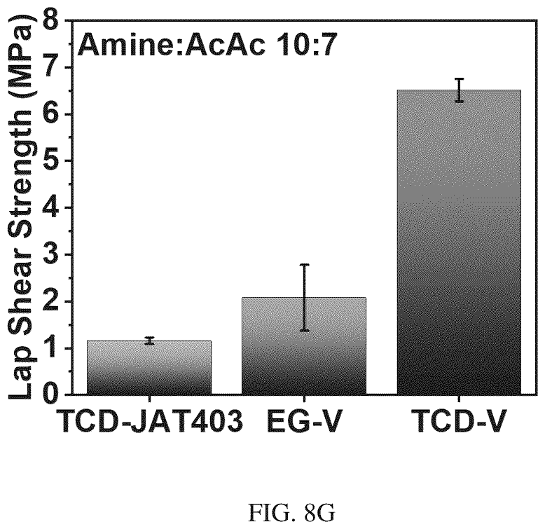

Underwater adhesion of 10:7 TCD-V on aluminum (Al) substrates was evaluated first. The viscous TCD-V (˜10 mg) was applied directly to submerged substrates using a syringe and joined together applying hand pressure (FIG. 8A), and this demonstrated immediate adhesion. The specimens were cured underwater at RT (˜18° C.) for 16 h under applied pressure (˜800 g weight) before lap shear testing. After curing, lap-shear strength was measured, and representative force-extension curves shown the figure FIG. 8B revealed substantial underwater adhesion (6.51 MPa).

To optimize the curing time, a series of Al substrates were joined underwater with the 10:7 TCD-V adhesive and allowed to cure at RT for 10 min, 1 h, 2 h, 4 h, 6 h, and 16 h before lap shear testing. The results (FIG. 8C) revealed that a minimum of 2 h was required to achieve high adhesion strength. Beyond this point, all samples exhibited comparable lap shear strength. Next, the effect of dynamic crosslinking density on the underwater adhesive performance of TCD-V on Al substrates was investigated. The tetraamine macromonomer allowed stoichiometric control of crosslinking density by varying the amount of TCDAcAc crosslinker. A possible outcome is that increased TCDAcAc concentration, and thus higher hydrophobicity and crosslinking, can enhance both bulk network integrity and underwater adhesion through water repellence. To test this, Al substrates were bonded underwater with varying amine: AcAc ratios (10:2, 10:3, 10:5, and 10:7). Underwater adhesion increased with the amine: AcAc ratio, where the 10:7 TCD-V exhibited the highest lap-shear strength (6.51 MPa) on Al (FIG. 8D). Conversely, 10:2 TCD-V showed minimal adhesion (22.2 kPa) (FIG. 8C). To quantify adhesive toughness, the work of debonding was calculated from the force-extension curves in the lap shear experiments (FIG. 8E). The integrated area underneath the force-extension curve is defined as the work of debonding, or work of adhesion, describing the energy required to break the adhesive joint. For the underwater samples, the surface area varied, but maintained ˜144 mm2 on average, following ASTM D1002. Following the same trend as the lap shear strength, the 10:7 exhibited the highest value for work of debonding (3,670 N.m-1) and 10:2 the lowest (FIG. 8E). The highly crosslinked and fully cured TCD-V adhesive network likely inhibited water permeation, thereby enhancing cohesive strength and thus underwater adhesion. Failure mode analysis supported this observation and showed adhesive failure for 10:7 TCD-V and cohesive failure for 10:2 TCD-V, thus indicating a weaker polymer network in the latter. A similar experiment was conducted to determine underwater adhesion in marine environments where the 10:7 TCD-V was cured at RT for 16 h in a solution of simulated seawater (3.5% NaCl). Though adhesion was diminished relative to the samples cured in DI water, it still exhibited strong underwater adhesion with a lap shear strength of 3.54 MPa.

Having established the influence of dynamic crosslink density and hydrophobicity of the TCD-V adhesive on lap-shear strength, the impact of substrate hydrophilicity on underwater adhesion was investigated. Two additional substrates with different wettability values were chosen, in this case, untreated steel and glass, and compared to the results from Al substrates. Glass possessed the highest wettability with a water contact angle of approximately ˜27°, followed by steel at ˜51°, and Al at ˜70°. Using the highest-performing 10:7 TCD-V adhesive formulation, it was observed that glass exhibited the lowest, though still high, adhesion (2.79 MPa). This result is likely due to rapid interaction between the glass and the surrounding water, forming a hydration layer on the substrate surface which hindered adhesion. Following the trend of substrate hydrophilicity, adhesion to steel (4.37 MPa) was greater than glass but weaker than the more hydrophobic Al (FIG. 8F). To validate the facial amphiphilic design of the presently described adhesive, the following two control formulations were synthesized: TCD-JAT403 and EG-V, both using a 10:7 amine: AcAc ratio (FIG. 8G). In TCD-JAT403, the amphiphilic PET-macromonomer was replaced with JAT403 to assess the role of the terephthalamide core. In EG-V, TCD-AcAc was substituted with EGAcAc to evaluate the importance of the facially amphiphilic TCD-AcAc component. The lap shear adhesion results revealed that the TCD-JAT403 exhibited weaker underwater adhesion strength (1.01 MPa; FIG. 3G). EG-V demonstrated improved underwater adhesion (2.07 MPa) compared to TCD-JAT403, yet still weaker than the 10:7 TCD-V adhesive (6.51 MPa). These results confirmed that both amphiphilic PET-JAT403 and the facially amphiphilic TCD-AcAc play a significant role in achieving strong underwater adhesion. A comparison of the underwater lap-shear strength on Al with literature values demonstrated that 10:7 TCD-V outperformed reported adhesives.

### Strong and Tough Adhesion for Structural Applications

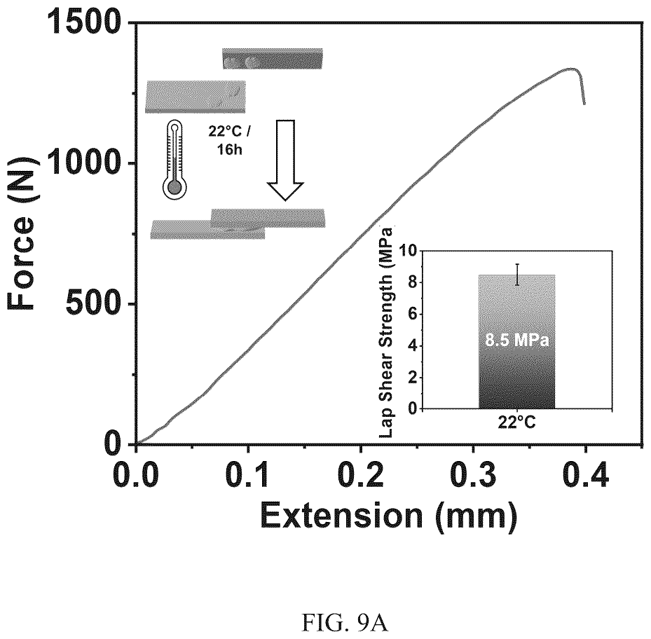

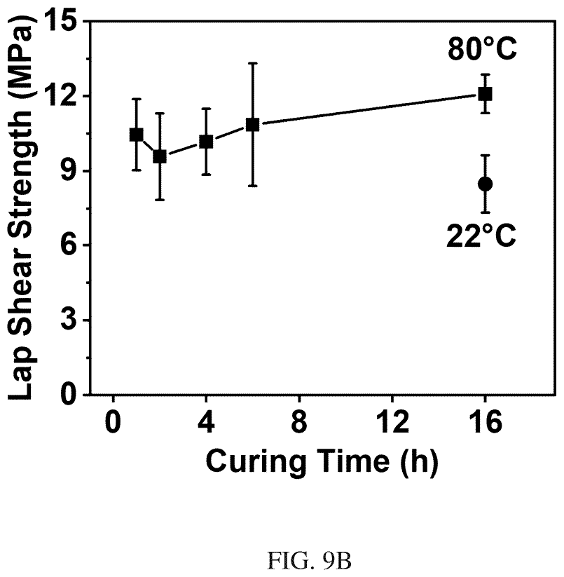

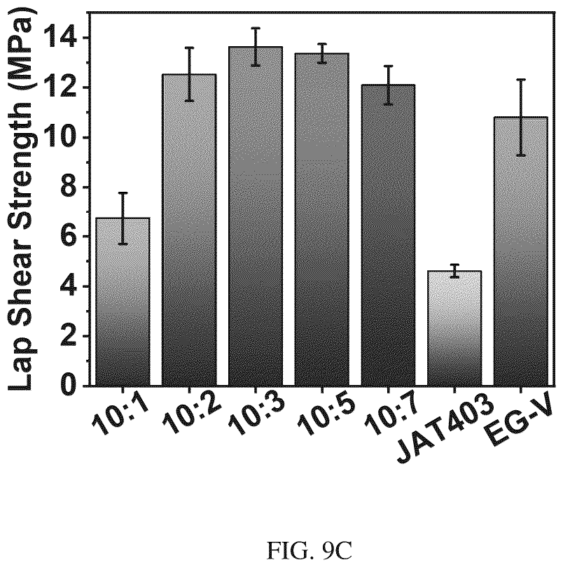

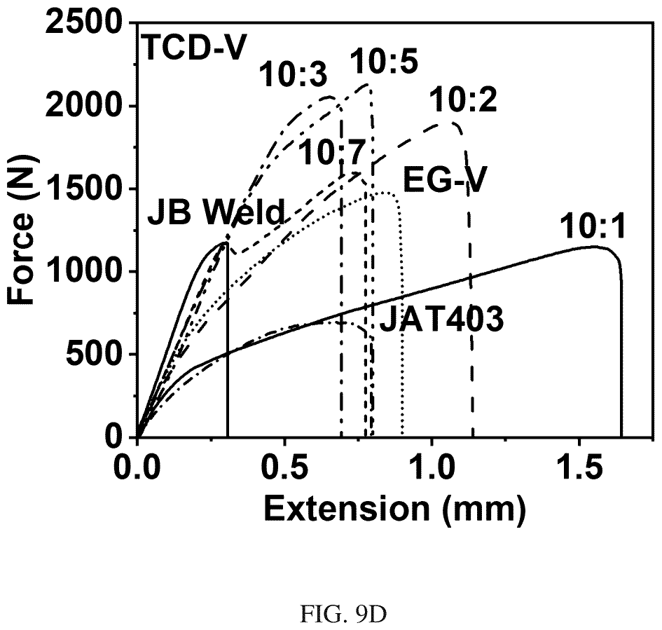

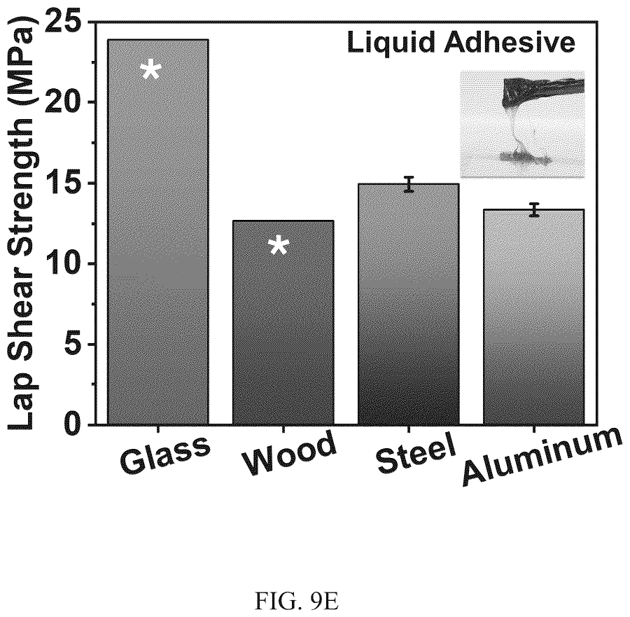

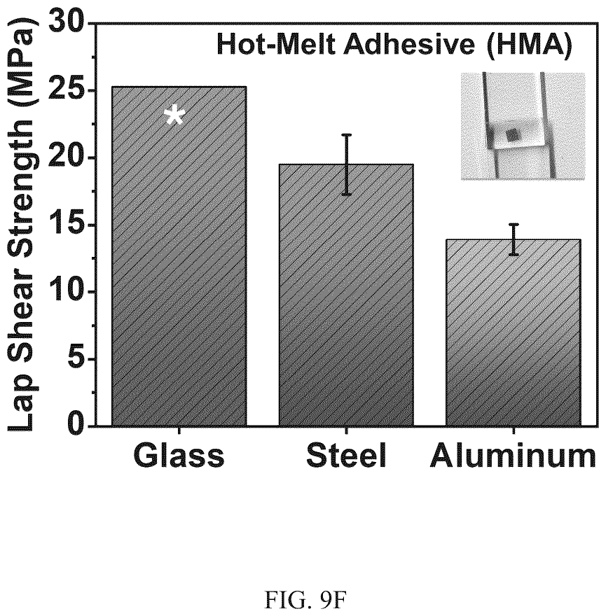

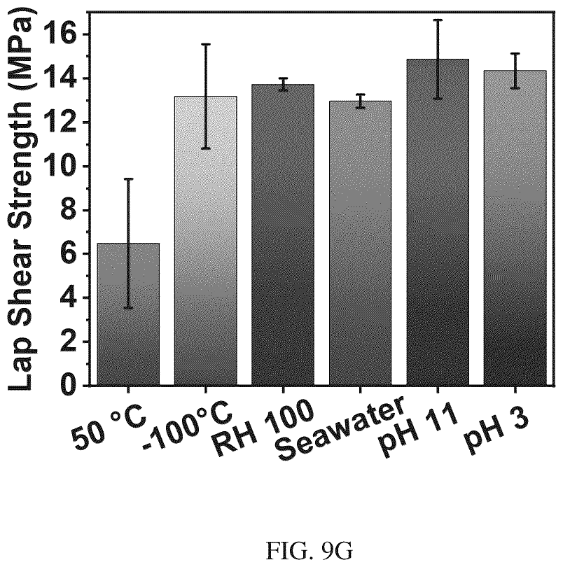

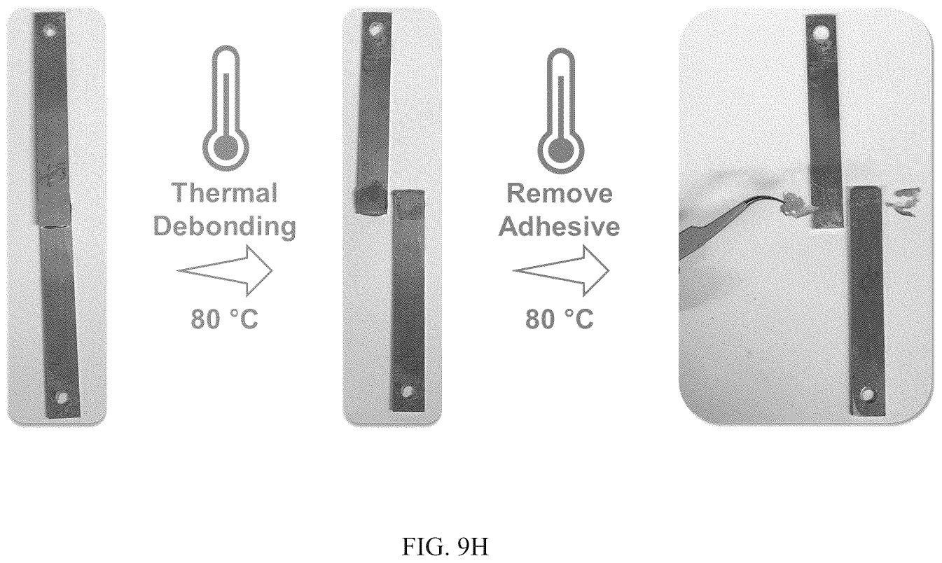

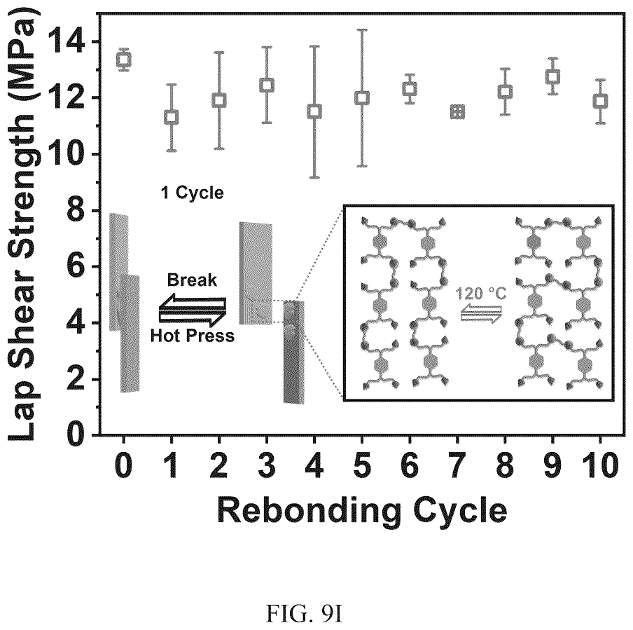

Beyond the underwater adhesive properties of TCD-V, its performance under dry conditions, particularly for structural applications, was also investigated. Initially, Al substrates and 10:7 TCD-V were used to investigate the effects of curing time and temperature. The TCD-V adhesive was applied to Al substrates by spreading the mixture evenly across the substrates such that ˜10 mg of adhesive was applied over a 144 mm2 area. After hand-pressing, the adhesive joint was cured at room temperature (RT) for 16 h before testing lap shear strength (FIG. 9A). The resulting lap-shear strength (8.48 MPa) of TCD-V demonstrated its potential as an RT-curable adhesive. To further optimize the formulation for RT curing, the same experiment was repeated under controlled pressure at 10 psi using a binder clip. Under these conditions, strong adhesion was achieved after only 4 h of RT curing, yielding a lap shear strength of 17.1 MPa. This enhancement is likely due to the applied pressure, promoting better surface wetting and facilitating higher non-covalent interactions at the adhesive-substrate interface. Building on the high strength of the RT-curable adhesive, the impact of higher-temperature curing was explored. Curing above the T_{g} promoted optimal rearrangement of the dynamic vinylogous urethane bonds, thus leading to stronger non-covalent interactions with hydroxy-terminated surfaces. To determine the optimal curing conditions, the T_{g} of the 10:7 TCD-V adhesive was first measured, which was found at 63.5° C. Subsequently, Al substrates bonded with the adhesive were cured at 80° C. for varying durations (1, 2, 4, 6, and 16 h) and then tested for lap shear strength at room temperature (FIG. 9B). Interestingly, samples cured for Ih achieved a lap shear strength of 10.5 MPa, while those cured for 6 h yielded 10.9 MPa. Both values are within the margin of error of the 16-hour result (12.1 MPa), thus indicating efficient and fast curing. While overall lap-shear strength remained similar, failure mode appeared to be influenced by curing time: shorter times resulted in more adhesive failures, while longer times showed more cohesive failures. Presumably, at short curing times, the reaction between macromonomer amines and acetoacetates proceeded faster than establishment of substrate interactions, leading to adhesive failure. Conversely, longer curing times allowed greater rearrangement of interactive groups and more complete curing within the adhesive, enhancing substrate adhesion and resulting in cohesive failure.

The influence of dynamic crosslink density on adhesion to Al substrates was investigated by varying the amount of TCDAcAc crosslinker. TCD-V adhesives with a series of amine: AcAc ratios, 10:1, 10:2, 10:3, and 10:5, were tested on Al after curing at 80° C. for 6 h. Interestingly, the lap shear adhesion strength trends observed in dry conditions were opposite to those observed for underwater adhesion. For example, the 10:3 and 10:5 formulations exhibited the highest lap shear strengths (13.6 and 13.4 MPa, respectively; FIG. 9C), whereas the 10:7 formulation yielded 12.1 MPa. This suggests that the higher concentration of unreacted primary amines in the 10:3 and 10:5 TCD-V formulations promoted stronger hydrogen bonding interactions with the substrate, as well as within the vitrimer network, leading to enhanced adhesion. Furthermore, 10:3 and 10:5 TCD-V showed lower T_{g} (45.3° C. and 58.4° C. respectively) which likely facilitated efficient network rearrangement at the interface, thus further enhancing noncovalent interactions and wettability. Conversely, the lower concentration of free amines and higher T_{g} of the 10:7 TCD-V (63.5° C.) adhesive may have hindered noncovalent interactions and network rearrangement in dry conditions.

Analogous to the above underwater adhesion study, next experiments investigated the role of facial amphiphilicity on structural adhesion performance. To assess the contribution of the terephthalamide core, a control adhesive (TCD-JAT403, 10:7 amine: AcAc) was tested on Al substrates. This control showed reduced lap shear strength (4.61 MPa) compared to TCD-V, despite identical amine functionality (FIG. 9C). This underscores the importance of the hydrophobic terephthalamide moiety in enhancing rigidity and cohesive strength. Another control adhesive, EG-V, designed to specifically evaluate facial amphiphilicity, demonstrated improved adhesion (10.8 MPa) compared to TCD-JAT403, yet still did not match the superior performance of 10:7 TCD-V (FIG. 9C). Collectively, these findings emphasize that both PET-JAT403 and TCD-AcAc components play an important role for optimal adhesive strength and toughness. The force-extension curves (FIG. 9D) show a sharp initial rise followed by a gradual increase in force until failure, indicating ductile, plastic behavior. This strain-hardening characteristic is rare among adhesives. The work of debonding was calculated from force-extension curves (FIG. 9D) and was greatest for the 10:2 TCD-V (9,010 N.m-1), nearly 6 times higher than commercial JB Weld epoxy (1,569 N.m-1). Most existing commercial structural adhesives are brittle, with low work of debonding values. The soft polypropylene oxide units of the PET macromonomer provided higher extensibility and an overall tougher adhesive, as they can dissipate mechanical stress throughout the joints and prevent abrupt failure. This enhanced toughness contributed to the high load-bearing capacity of these adhesives (FIG. 6), thus permitting them to mitigate premature adhesive failures and making them highly desirable for structural applications. Notably, the lap shear strength of the presently described adhesive outperforms current literature benchmarks.

The TCD-V adhesive demonstrated versatile adhesion to various hydroxylated surfaces, including common structural substrates such as steel, wood, and glass. The same methodology used for the Al tests was applied to these substrates, utilizing the 10:5 TCD-V given that it exhibited a very high work of debonding while maintaining a high lap shear strength. Impressively, lap shear tests from steel surpassed that of the Al substrates with an ultimate strength of 14.9 MPa and a work of debonding equal to 7,780 N.m-′ (FIG. 9E). For glass, the procedure was modified to avoid premature breakage of the glass substrate by reducing the working area from 144 mm2 to 36.0 mm2. Even so, substrate failure was still an issue—the glass shattered well in advance of damage to the adhesive joint, but not before exhibiting lap shear strengths upwards of 20.0 MPa. This performance was due to the high density of hydroxyl groups inherent to the chemical structure of borosilicate glass. This experiment was repeated with the original testing area (144 mm2) on sanded wood substrates. The lap shear testing again resulted in substrate failure, where the wood, much like the glass, sheared off near the adhesive joint following the grain line. In this case, the strong adhesion was likely due to the high density of hydroxyl groups in cellulose and increased wettability granted by the porosity of the wood.

Given the observed strong adhesion to various hydroxyl-containing surfaces, next experiments investigated whether this adhesion could be maintained between dissimilar substrates—a crucial requirement in automotive and aerospace applications, where joining composites to metals like aluminum or steel presents significant challenges. Both glass and carbon fiber reinforced polymers (GFRP and CFRP) were joined to Al using the 10:5 TCD-V adhesive and measured lap shear strengths. Both joints exhibited remarkably high lap shear strengths (11.1 MPa and 15.7 MPa for the GFRP and CFRP respectively). The solid film of TCD-V was also utilized as a hot melt adhesive (HMA) on various substrates (e.g., Al. Steel and Glass). At temperatures above the Ts, the TCD. V film underwent continuous bond exchange/cleavage resulting in reduced viscosity and promoting wetting of the substrate. The lap shear strength of the solid adhesive was measured using a 6 mm×6 mm of the 10:5 TCD-V for aluminum and steel substrates and a 2 mm×2 mm for the glass substrates. Wood was not used for this experiment given its poor thermal conductivity. The pieces of TCD-V were placed between the substrates and pressed at 120° C., and 500 psi for 1 h on a Carver press. The hot-melt adhesive (HMA) performed in alignment with the trend established by the liquid adhesive, with steel (19.5 MPa) exceeding aluminum (13.9 MPa) (FIG. 9F). Like the liquid adhesive, the glass exhibited structural failure well before adhesive failure despite displaying a high lap shear strength (>25 MPa) (FIG. 9F). The HMA was robust for all tested substrates and implied that both methods of application (liquid or solid) are viable for the TCD-V adhesive.

To assess adaptability to harsh environmental conditions, the performance of the TCD-V adhesive across a wide temperature range was evaluated. We measured the lap shear strength of 10:5 TCD-V adhesive at 50° C. on Al substrates and achieved at 6.48 MPa (FIG. 9G), slightly lower than that at RT value, likely due to the proximity of the testing temperature to the measured T& (63.5° C.) of 10:5 TCD-V. At much lower (−100° C.) temperatures, the adhesive maintained high lap shear strength of 13.2 MPa even after a 2-minutes exposure to liquid nitrogen. This resilience at low temperatures is likely due to the high modulus of TCD-V at −50° C. Furthermore, the adhesive demonstrated excellent durability under extreme humidity. For example, after two days of submersion in water at room temperature (RH 100), the lap shear strength of Al substrates remained unchanged at 13.7 MPa (FIG. 9G). With the promising results from the submerged samples, more extreme conditions were explored, including corrosive solutions of simulated seawater (13.0 MPa), base (pH=11) (14.9 MPa), and acid (pH=3) (14.3 MPa). Notably, strong adhesion was maintained across all tested extreme environmental conditions (FIG. 9G). These results highlight the TCD-V adhesive's resilience and versatility, making it a promising candidate for applications demanding high performance and stability in harsh environments.

The dynamic covalent vinylogous urethane and noncovalent bonds (hydrogen bonding and van der Waals interactions) within TCD-V enable reversible macroscopic responses to thermal stimuli, making it a promising reusable structural adhesive. Unlike most commercial adhesives, TCD-V can heal broken joints upon heating above its T_{g}. which permitted easy removal of adhesive from the substrates at 80° C. (FIG. 9H). While most adhesives require extreme temperatures for removal (either through thermal degradation or heating above their T_{g}, the presently described adhesive provides facile detachment and rebonding at moderate conditions, facilitated by dynamic vinylogous urethane bond exchange, thus providing a practical and energy-efficient alternative. The rebonding capability of the TCD-V was assessed through a cyclic sequence of breaking the lap joint of Al substrates at RT and subsequent healing of the joint at elevated temperature (120° C.) and applied pressure (500 psi) (FIG. 91). The average lap shear strength remained above 11.5 MPa over 10 cycles, demonstrating consistent performance despite minor variations likely attributed to inconsistencies in pressing small material amounts and the presence of imperfections (e.g., dust, bubbles, detritus). This sustained strength demonstrates a significant advantage over traditional adhesives. Furthermore, the TCD-V adhesive is completely chemically recyclable, where the PET-JAT403 macromonomer can be recovered by cleaving the vinylogous urethane bond with excess amine. To further evaluate the efficacy of the high-performance reversible adhesive for practical applications, its lap shear strength was compared to that of commonly used commercial adhesives, including JB Weld (epoxy), Loctite 416 and Loctite Professional Liquid (both ethyl cyanoacrylates), and Gorilla Glue (polyurethane). Both the 10:5 TCD-V liquid and hot melt adhesive (HMA) formulations outperformed all four commercial adhesives on Al substrates (144 mm2 area, cured according to manufacturer instructions).

### Pressure-Sensitive Adhesive Application

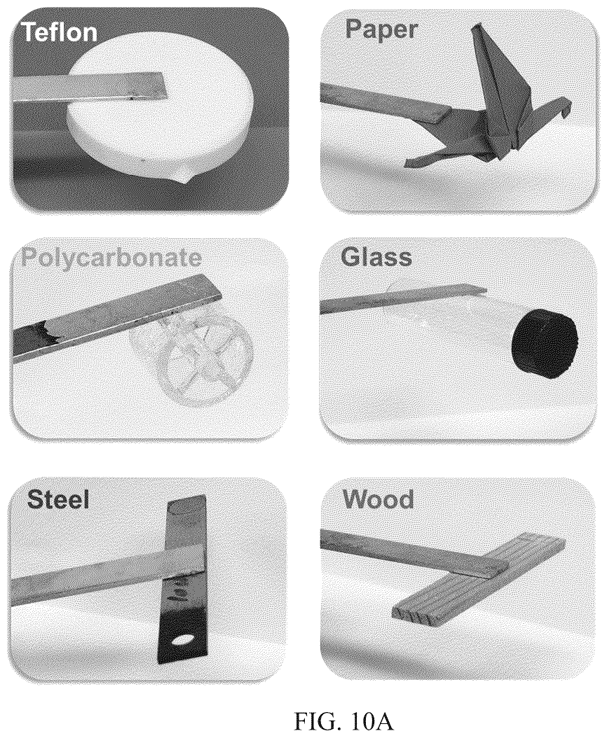

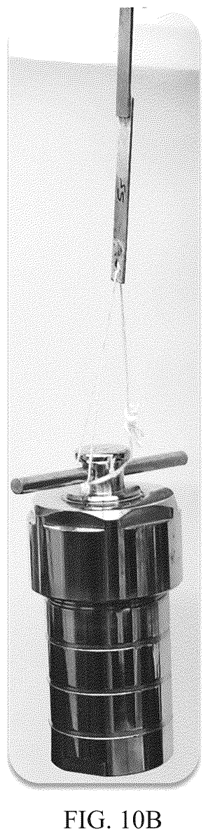

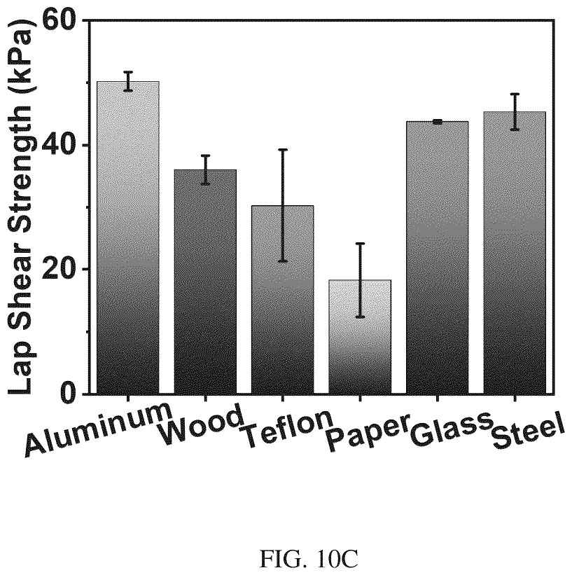

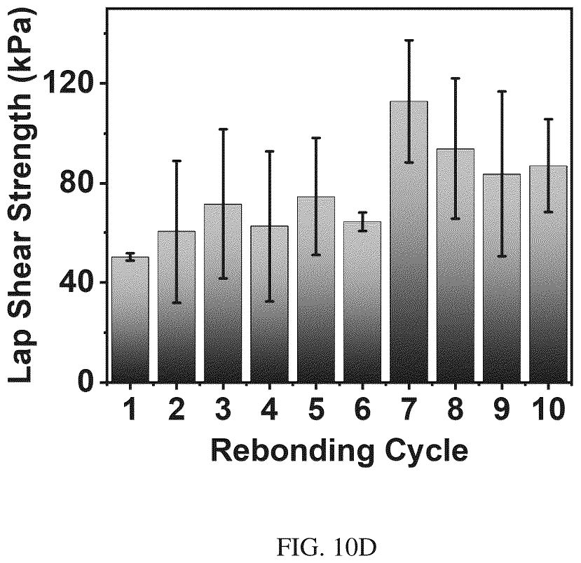

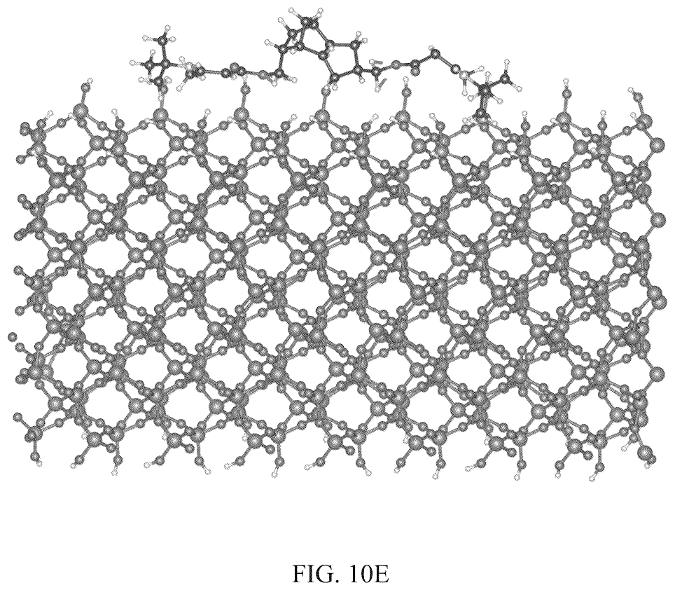

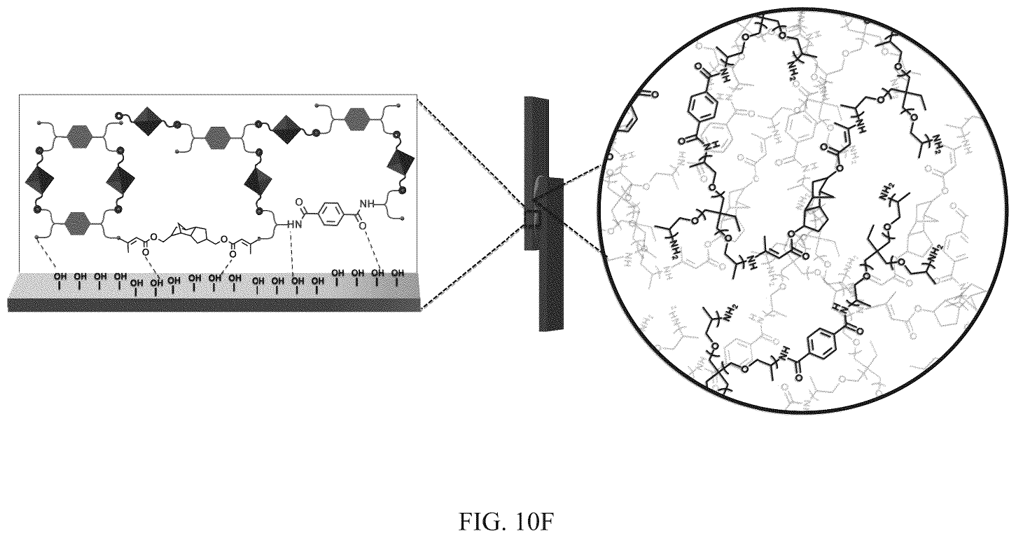

Having demonstrated the tunability of TCD-V adhesive for both underwater and structural applications by controlling the degree of crosslinking, next experiments investigated its potential for pressure-sensitive applications. Pressure-sensitive adhesives (PSAs) are commonly used for temporary bonding, requiring rapid and relatively weak adhesion, as exemplified by adhesive tapes, bandages, and sticky notes. PSA adhesion relies on pressure-induced non-covalent surface interactions without the need for heat or irradiation. The adhesion of PSAs is aided by their low T_{g} which facilitates surface wetting at room temperature. It can be hypothesized that low crosslinking densities would decrease T_{g} and increase free amine density, thus promoting pressure-sensitive adhesion through non-covalent interactions with hydroxyl surfaces. To test this hypothesis, the PET-macromonomer was reacted with the TCDAcAc in a 10:0.5 amine: AcAc ratio by mixing the two components together in a scintillation vial and curing for 1 h at 80° C. to complete crosslinking. The resulting viscous gel showed a low T_{g} of 11.8° C., making it a potential candidate for PSA in ambient conditions. Subsequently, a series of experiments were completed where the adhesive was applied as a glue over a surface area of 144 mm2 on an Al substrate and was attached by hand to several different materials. The 10:0.5 TCD-V showed adhesion to all tested substrates (Teflon, paper, polycarbonate, glass, steel and wood) and was later easily removed from the surfaces (FIG. 10A). To quantify this adhesion, substrates were prepared out of each material and were overlapped to form an adhesive joint of approximately 144 mm2 with the 10:0.5 TCD-V adhesive before pressing for 10 min with an 800 g weight. After the allotted time, the specimens were tested for load-bearing capacity and lap shear strength (FIGS. 10B and 10C). All substrates showed reversible adhesion on the kPa scale. The highest adhesion was observed for the Al, steel and glass substrates with lap shear strengths of 50.2, 45.3, and 43.7 kPa respectively. PSAs ideally exhibit reusability, reforming bonds after joint failure. The rebonding capability of 10:0.5 TCD-V on aluminum substrates was evaluated through repeated lap-shear testing. After breakage of the joint, the substrates were realigned and weighted with an 800 g weight for 10 minutes to maximize adhesion before testing for lap-shear strength. Over 10 cycles, no adhesion loss was observed (FIG. 10D), demonstrating the TCD-V adhesive is a promising candidate for PSA applications. To investigate the influence of high-pressure environments on TCD-V adhesion, a secondary experiment was conducted using a carver press at 145 psi. The resulting adhesion was greatly increased, reaching a maximum of 563 kPa. However, this enhanced adhesion diminished after four cycles, potentially due to adhesive leakage from the joint, resulting in reduced adhesive residue on the bonding surfaces.

After investigating pressure-sensitive adhesion, a preliminary life-cycle analysis (LCA) was conducted to assess the adhesive's sustainability. The LCA was conducted using model compounds to represent the bench-top synthesis. Results from the analysis revealed carbon footprints of less than 3 kg CO2/kg for both PET-JAT403 and TCDAcAc (2.29 and 2.68 kg CO2/kg, respectively). These values are favorably low compared to typically reported reagents used in synthetic chemistry. Further modeling of the adhesive's carbon footprint resulted in a value of 2.39 kg CO2/kg for the TCD-V, representing a great improvement over similar structural adhesives currently in use. Mechanism for tough reversible adhesion

To further elucidate the underlying mechanism that provides the TCD-V adhesive with such versatile, tough, and reversible adhesion, an investigation of its adhesive properties was conducted using density functional theory (DFT) calculations (FIG. 10E). For DFT calculations, a model of hydroxylated silica was used to mimic the hydroxy substrates. DFT calculations revealed that TCD-V can form intermolecular and intramolecular hydrogen-bonding (H-bonding) using several potential H-bonding interaction sites between TCD-V and the substrate, including primary amines, amides on the terephthalamide core, and esters from the acetoacetate crosslinkers. These calculations further indicated that the tricyclic ring of the TCDAcAc crosslinker preferentially orients carboxyl groups toward hydroxylated surfaces at a distance of approximately ˜1.7 Å (FIG. 10E), which indicates facial amphiphilicity. For each TCDAcAc unit near a surface, two moderately strong H-bonds are formed and contribute to a binding energy of 115.3 kcal/mol.

Additional DFT calculations for interactions between the terephthalamide core and hydroxylated surfaces were performed, accounting for N—H, N—H2, and C═O bonds present in the amphiphilic macromonomer structure. These functional groups were also found to form strong H-bonding interactions with the simulated surfaces, exhibiting an overall large binding energy of 187.1 kcal/mol, consistent with the high adhesion of the TCD-V. The proposed mechanism of adhesion involves synergistic contributions from cohesive and adhesive interactions. Specifically, intermolecular H-bonding and vinylogous urethane dynamic covalent bonding within the TCD-V adhesive significantly enhanced its cohesive strength. Concurrently, non-covalent interactions between hydroxyl-terminated substrates and the TCD-V adhesive bolstered interfacial adhesion (FIG. 10F).

Collectively, these dynamic physical and chemical bonds facilitated the surface contact at macroscopic and microscopic scales and improved both cohesive and adhesive forces. To permit reversibility, the energy input needed to exceed the calculated binding energies, which was achieved in this work by use of elevated temperatures (˜80-120° C.). Upon heating, the TCD-V network reorients, aligning electron donors toward hydroxylated substrate surfaces and facilitating dynamic bond exchange and reformation. This realignment re-establishes key physical interactions identified by DFT, including hydrogen bonding, metal-ion coordination with oxygen, and van der Waals forces, thereby maximizing adhesive strength. Furthermore, the presence of multiple dynamic hydrogen and vinylogous urethane bonds provides the retention of adhesion even after 10 thermal reprocessing cycles.

To investigate the underwater adhesive properties of TCD-V, a continuum water model was used to compute the binding energy under aqueous conditions. DFT calculations showed that the underwater binding energy of TCD-V to the surface decreased (˜47.3 kcal/mol) compared to vacuum conditions, and the distance between TCD-V and the surface increased slightly (C═O—H distance ˜1.73 Å). Despite this reduction, the underwater adhesive performance remained relatively strong. The adhesion mechanism governed by hydrogen bonding remained similar to vacuum conditions; however, these interactions are partially screened by water, which weakens their overall effect. These findings aligned with experimental observations where more hydrophobic surfaces (e.g., Al) exhibited stronger adhesion than hydrophilic ones (e.g., glass). The strong adhesion, reprocessability, and versatility of TCD-V highlight the potential of dynamically bonded networks for advanced adhesive design.

This work demonstrated a bioinspired design strategy based on facial amphiphilicity and dynamic interactions to develop a versatile, tough, and reversible adhesive derived from post-consumer PET waste. This approach addressed a long-standing challenge in adhesive technology: achieving strong, reversible adhesion in both underwater and dry environments, while maintaining sustainability and recyclability. The above described adhesive system was constructed from a PET-derived amphiphilic macromonomer featuring a hydrophobic terephthalamide core and hydrophilic, amine-terminated propylene glycol arms, combined with a facially amphiphilic di-acetoacetate crosslinker to form dynamic vinylogous urethane bonds. This solvent-free and room temperature curable formulation yielded a robust adhesive network with local amphiphilicity, thereby providing strong interfacial interactions. The resulting adhesives demonstrated high performance across diverse applications, from underwater and structural to pressure-sensitive adhesion. Notably, the 10:7 TCD-V achieved an underwater lap shear strength of 6.51 MPa on Al, outperforming most literature-reported underwater adhesives. This enhanced underwater performance is attributed to the hydrophobic, rigid terephthalamide core and facially amphiphilic tricyclic structure, which minimizes water ingress and preserves network integrity under wet conditions.

In dry conditions, the described adhesives maintained strong adhesion to a wide range of structural substrates, including glass, Al, steel, wood, and even dissimilar substrate pairings such as metal-composite interfaces. In extreme environmental conditions, including simulated seawater, high humidity, high/low pH, very low temperature, and moderately high temperature, the present adhesive exhibited strong lap shear strength. In comparison to several widely used commercial adhesives, the present adhesive showed either superior or competitive lap shear strength and toughness. This superior performance arises from the synergistic interplay of dynamic covalent and non-covalent interactions both within the adhesive network and at the substrate interface. DFT calculations revealed that facially amphiphilic molecular design enabled electronegative atoms preferentially orient toward substrate surfaces, promotes multiple interactions (e.g., hydrogen bonding and van der Waal's) across interfaces.

The incorporation of dynamic covalent bonds conferred key advantages: reversible adhesion without performance degradation over multiple cycles, facile removal from surfaces, and chemical recyclability, which arefeatures absent in most commercial adhesives. Furthermore, by tuning the crosslinker concentration, a pressure-sensitive adhesion with good lap shear strength on both hydroxylated and fluorinated surfaces was achieved. A preliminary LCA indicates that these adhesives are environmentally competitive with current alternatives. Further reduction in the carbon footprint could be achieved by substituting the JAT403 component with bio-derived amines. In summary, this work demonstrates the successful upcycling of post-consumer PET plastic waste into a versatile, high-performance, reversible, and sustainable adhesive. The adhesive's superior performance in both dry and wet environments, combined with its reversible and recyclable nature, provides a sustainable solution for plastic waste management and offers significant commercial potential.

While there have been shown and described what are at present considered the preferred embodiments of the invention, those skilled in the art may make various changes and modifications which remain within the scope of the invention defined by the appended claims.

What is claimed is:

1. An amine-containing compound having the following formula: 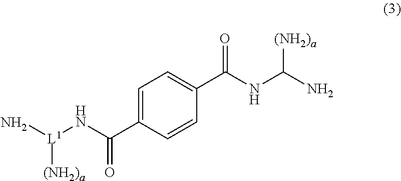
wherein:
L¹ is independently selected, in each instance, from hydrocarbon linkers containing at least three carbon atoms and optionally containing one or more heteroatoms selected from N, O, S, and Si; and
subscript a is independently selected, in each instance, from an integer of at least 1.

2. The compound of claim 1, wherein L¹ is independently selected from hydrocarbon linkers containing at least four carbon atoms and optionally one or more heteroatoms selected from N, O, S, and Si.

3. The compound of claim 1, wherein L¹ is independently selected from hydrocarbon linkers containing at least ten carbon atoms and optionally one or more heteroatoms selected from N, O, S, and Si.

4. The compound of claim 1, wherein each L¹ contains at least one —CH₂CH₂O— or —CH(CH₃)CH₂O— linkage.

5. The compound of claim 1, wherein the subscript a is independently selected, in each instance, from an integer of at least 2.

6. A vinylogous urethane compound having the following formula: 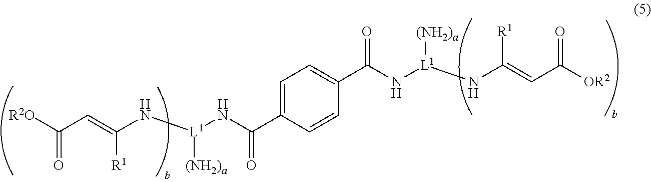
wherein:
L¹ is independently selected, in each instance, from hydrocarbon linkers containing at least three carbon atoms and optionally one or more heteroatoms selected from N, O, S, and Si;
R¹ is independently, in each instance, selected from H atom and hydrocarbon groups containing 1-3 carbon atoms;
R² is independently, in each instance, selected from hydrocarbon groups containing at least one carbon atom and optionally containing one or more heteroatoms selected from N, O, S, and Si wherein, optionally, two R² groups from different molecules of Formula (5) may interconnect, optionally repetitively, through a hydrocarbon linker L³ containing at least one carbon atom and optionally one or more heteroatoms selected from N, O, S, and Si;
subscript a is independently selected, in each instance, from 0 or an integer of at least 1; and
subscript b is independently selected, in each instance, from an integer of at least 1.

7. The compound of claim 6, wherein two R² groups from different molecules of Formula (5) may interconnect, optionally repetitively, through a hydrocarbon linker L³ containing at least one carbon atom and optionally one or more heteroatoms selected from N, O, S, and Si.

8. A vitrimer adhesive polymer comprising A and B units, defined as follows: 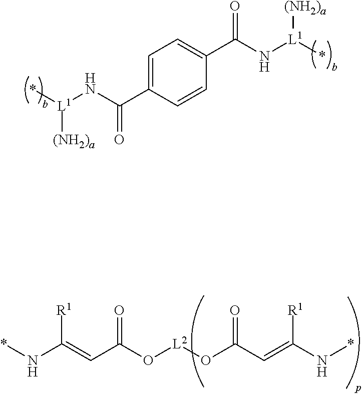
wherein:
the asterisks (*) in A units represent covalent bond connection points with asterisks in B units;
L¹ is independently selected, in each instance, from hydrocarbon linkers containing at least three carbon atoms and optionally containing one or more heteroatoms selected from N, O, S, and Si;
L² represents a hydrocarbon linker containing 1-50 carbon atoms and optionally containing one or more heteroatoms selected from N, O, S, and Si;
R¹ is independently, in each instance, selected from H atom and hydrocarbon groups containing 1-3 carbon atoms;
subscript a is independently, in each instance, an integer of at least 1;
subscript b is independently, in each instance, an integer of at least 1; and
subscript p is an integer of 1-5.

9. The polymer of claim 8, wherein L¹ is independently selected from hydrocarbon linkers containing at least four carbon atoms and optionally one or more heteroatoms selected from N, O, S, and Si.

10. The polymer of claim 8, wherein L¹ is independently selected from hydrocarbon linkers containing at least ten carbon atoms and optionally one or more heteroatoms selected from N, O, S, and Si.

11. The polymer of claim 8, wherein each L¹ contains at least one —CH₂CH₂O— or —CH(CH₃)CH₂O— linkage.

12. The polymer of claim 8, wherein L² contains a cyclic linking group.

13. A method of deconstructing and upcycling used polymeric material containing carbonyl groups in the backbone of the polymer, the method comprising:
(i) reacting said polymeric material with a polyamine molecule under conditions that result in covalent attachment of the polyamine molecule with the polymer in the polymeric material to produce an aminated monomer, wherein said aminated monomer contains a multiplicity of free unreacted amino groups from the polyamine molecule, and said polyamine molecule contains at least three amino groups; and
(ii) reacting said aminated monomer with a poly(acylacetate) compound of the formula: 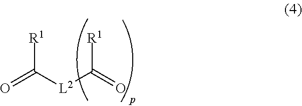
wherein:
L² represents a hydrocarbon linker containing 1-50 carbon atoms and optionally containing one or more heteroatoms selected from N, O, S, and Si, wherein L² contains at least one ester-containing group of the formula —CH₂C(O)O—;
R¹ is independently, in each instance, selected from H atom and hydrocarbon groups containing 1-3 carbon atoms; and
p is an integer of 1-5;
under conditions that result in reaction between a portion of said free unreacted amino groups in said aminated monomer and carbonyl groups in the bis(acylacetate) compound of Formula (3) to result in a crosslinked polymer containing vinylogous urethane covalent linkages and free unreacted amino groups.

14. The method of claim 13, wherein said polymeric material comprises one or more polymers selected from the group consisting of polyesters, polycarbonates, polyamides, and polyurethanes.

15. The method of claim 13, wherein said polymeric material comprises polyethylene terephthalate (PET), wherein:
step (i) proceeds by the following reaction: 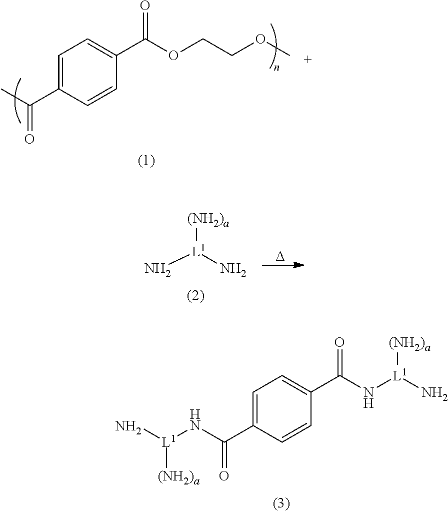
wherein L¹ is independently selected, in each instance, from hydrocarbon linkers containing at least three carbon atoms and optionally containing one or more heteroatoms selected from N, O, S, and Si; and subscript a is independently, in each instance, an integer of at least 1;
and step (ii) produces a crosslinked vitrimer polymer comprising A and B units in accordance with the following scheme: 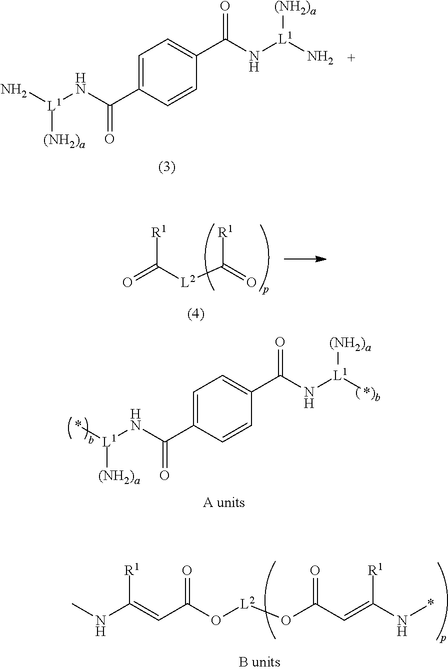
wherein:
the asterisks (*) in A units represent covalent bond connection points with asterisks in B units;
L¹ independently selected, in each instance, from hydrocarbon linkers containing at least three carbon atoms and optionally containing one or more heteroatoms selected from N, O, S, and Si;
L² represents a hydrocarbon linker containing 1-50 carbon atoms and optionally containing one or more heteroatoms selected from N, O, S, and Si;
R¹ is independently, in each instance, selected from H atom and hydrocarbon groups containing 1-3 carbon atoms;
subscript a is independently, in each instance, an integer of at least 1;
subscript b is independently, in each instance, an integer of at least 1; and
subscript p is an integer of 1-5.

16. The method of claim 15, wherein L¹ is independently selected from hydrocarbon linkers containing at least four carbon atoms and optionally one or more heteroatoms selected from N, O, S, and Si.

17. The method of claim 15, wherein L¹ is independently selected from hydrocarbon linkers containing at least ten carbon atoms and optionally one or more heteroatoms selected from N, O, S, and Si.

18. The method of claim 15, wherein each L¹ contains at least one —CH₂CH₂O— or —CH(CH₃)CH₂O— linkage.

19. The method of claim 15, wherein L² contains a cyclic linking group.

20. A method of bonding first and second surfaces together, the method comprising placing an adhesive composition between the first and second surfaces and hot pressing the surfaces at a temperature of 80° C. to 200° C., wherein the adhesive composition comprises a vitrimer adhesive polymer comprising A and B units, defined as follows: 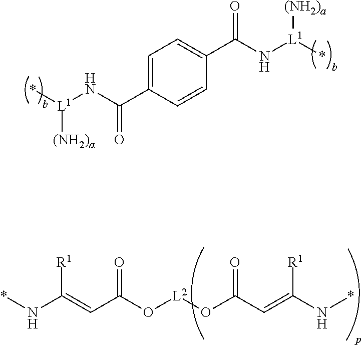
wherein:
the asterisks (*) in A units represent covalent bond connection points with asterisks in B units;
L¹ independently selected, in each instance, from hydrocarbon linkers containing at least three carbon atoms and optionally containing one or more heteroatoms selected from N, O, S, and Si;
L² represents a hydrocarbon linker containing 1-50 carbon atoms and optionally containing one or more heteroatoms selected from N, O, S, and Si;
R¹ is independently, in each instance, selected from H atom and hydrocarbon groups containing 1-3 carbon atoms;
subscript a is independently, in each instance, an integer of at least 1;
subscript b is independently, in each instance, an integer of at least 1; and
subscript p is an integer of 1-5.

21. The method of claim 20, wherein at least one of the first and second surfaces is a metal surface.

22. The method of claim 20, wherein at least one of the first and second surfaces is a polymer matrix composite surface.

23. The method of claim 20, wherein each L¹ contains at least one —CH₂CH₂O— or —CH(CH₃)CH₂O— linkage.

24. The method of claim 20, wherein L² contains a cyclic linking group.
